(19) United States
(12) Patent Application Publication
(10) Pub. No.: US 2015/0310342 A1
(43) Pub. Date: Oct. 29, 2015

(54) OVERLAY AUTOMATA APPROACH TO REGULAR EXPRESSION MATCHING FOR INTRUSION DETECTION AND PREVENTION SYSTEM

(71) Applicant: Board Of Trustees Of Michigan State University, East Lansing, MI (US)

(72) Inventors: Alex Liu, Okemos, MI (US); Eric Torng, East Lansing, MI (US)

(21) Appl. No.: 14/697,301

(22) Filed: Apr. 27, 2015

Related U.S. Application Data
(60) Provisional application No. 61/984,642, filed on Apr. 25, 2014.

(51) Int. Cl. G06N 5/04; H04L 29/06

(52) U.S. Cl. CPC G06N 5/047; H04L 69/22

(57) ABSTRACT

Embodiments are described for automata models for use in deep packet inspection. Various embodiments are described for a new automata model, Overlay DFA (ODFA), which captures state replication in DFAs. Additional embodiments include combining the ODFA model with a D2FA model to provide an Overlay Delayed Input DFA (OD2FA). As the DFA model captures transition sharing, the OD2FA model captures both state replication and transition sharing. Algorithms are disclosed for efficiently constructing the OD2FA model and for implementing the OD2FA model in Ternary Content Addressable Memory (TCAM).

### Cross Reference to Related Application

This application claims the benefit of U.S. Provisional Patent Application No. 61/984,642 entitled “An Overlay Automata Approach to Regular Expression Matching for Matching Intrusion Detection and Prevention Systems,” filed Apr. 25, 2014, the disclosure of which is hereby expressly incorporated by reference in its entirety.

### STATEMENT OF GOVERNMENTAL INTEREST

This invention was made with government support under CCF-1347953, awarded by the National Science Foundation. The Government has certain rights in the invention.

### FIELD OF THE DISCLOSURE

The present disclosure relates generally to deterministic finite state automata (DFA) models for regular expression (RegEx) matching, and more particularly, to methods and systems for using state replication and transition sharing within DFA models to improve DFA modeling efficiency and their implementation.

### BACKGROUND

Deep packet inspection (DPI) is the core operation for a variety of devices, such as routers, Network Intrusion Detection (or Prevention) Systems (NIDS/NIPS), firewalls, and layer 7 switches, for a variety of services, such as malware filtering, attack detection, traffic monitoring, and application protocol identification. In the past, DPI was often accomplished by string matching, i.e., finding which strings in a set of predefined strings match the payload of a packet. Now, DPI is typically accomplished by regular expression (RegEx) matching, i.e., finding which RegExes in a set of predefined RegExes match the payload of a packet. RegExes are fundamentally more expressive, efficient, and flexible for specifying attack or malware signatures. Most open source and commercial intrusion detection and prevention systems, such as Snort, Bro, and HP TippingPoint, use RegEx matching to implement DPI. Modern operating systems such as Cisco IOS and Linux have even built RegEx matching modules for layer 7 filtering.

Because DPI on networking devices processes packets at wire speed, high speed RegEx matching is typically based on the Deterministic Finite State Automata (DFA) model of RegExes, because a DFA maintains a single active state and thus requires only one lookup for each input character. The primary alternative, the Non-deterministic Finite State Automata (NFA) model, maintains multiple active states and thus requires multiple lookups (one per active state) for each input character.

However, the DFA model requires a large amount of memory for implementation. For example, for many RegEx sets, the corresponding DFA is too large to fit in SRAM memory. In such cases, the DFA cannot be built, and if it can be built, it is stored in DRAM memory, which is orders of magnitude slower than SRAM memory. DFAs are typically very large since each state requires 256 transitions and because of state explosion due to state replication. State explosion refers to the phenomenon that occurs from the number of DFA states potentially being exponential in the size and number of the input RegExes. In particular, if the input RegExes contain “*s” expressions, the NFA states that correspond to each RegEx can be replicated an exponential number of times. Likewise, transitions are replicated for each replicated state. NFAs also store 256 transitions per state, but the number of NFA states is linear in the number of RegExes. Therefore, providing a fast and efficient implementation of the DFA model using RegEx sets that does not utilize large amounts of memory presents several challenges.

### SUMMARY OF THE DISCLOSURE

Method, systems, apparatus, and tangible non-transitory media are described that enable a new automata model, Overlay DFA (ODFA), which captures state replication in DFAs. Additional embodiments include combining the ODFA model with a delayed DFA (D²FA) model, which captures transition sharing, to provide an Overlay Delayed Input DFA (OD²FA) that captures both state replication and transition sharing. An algorithm is also disclosed for efficiently constructing OD²FA, and an OverlayCAM algorithm is disclosed for implementing OD²FA in Ternary Content Addressable Memory (TCAM). As discussed in other examples throughout the disclosure, the OD²FA techniques presented herein may be implemented in software in any suitable computer memory.

### BRIEF DESCRIPTION OF THE DRAWINGS

FIG. 1 is a block diagram of the relationship between automata models in accordance with an exemplary embodiment of the present disclosure;

FIG. 2A is a block diagram of an example DFA for a RegEx set {/abc/, /abd/} in accordance with an exemplary embodiment of the present disclosure;

FIG. 2B is a block diagram of an example DFA for a RegEx set {/abc/, /abd/, /e.*f/} in accordance with an exemplary embodiment of the present disclosure;

FIG. 2C is a block diagram of an example overlayed DFA (ODFA) for the RegEx set shown in FIG. 2B having six super-states in accordance with an exemplary embodiment of the present disclosure;

FIG. 2D is a block diagram of an example overlayed DFA (ODFA) for the OFDA shown in FIG. 2C having super-state transitions in accordance with an exemplary embodiment of the present disclosure;

FIG. 3A is a block diagram of an example D²FA for a RegEx set {/abc/, /abd/, /e.*f/} in accordance with an exemplary embodiment of the present disclosure;

FIG. 3B is a block diagram of an example OD²FA for the RegEx set shown in FIG. 3A in accordance with an exemplary embodiment of the present disclosure;

FIG. 4A is a block diagram of an example D²FA for the RegEx /a.*b..c/ having non self-looping roots in accordance with an exemplary embodiment of the present disclosure;

FIG. 4B is a block diagram of an example D²FA for the RegEx shown in FIG. 4A after settling deferment for non self-looping root states in accordance with an exemplary embodiment of the present disclosure;

FIG. 5 is a block diagram of an example OD²FA construction corresponding to a RegEx /ab[̂ n]*pq/ in accordance with an exemplary embodiment of the present disclosure;

FIG. 6 is a block diagram of example D²FA and OD²FA corresponding to a RegEx /cd[̂n]*pr/ in accordance with an exemplary embodiment of the present disclosure;

FIG. 7A is a block diagram of an example merged D²FA construction from the two D²FAs shown in FIGS. 5 and 6, respectively, in accordance with an exemplary embodiment of the present disclosure;

FIG. 7B is a block diagram of an example merged OD²FA construction from the two OD²FAs shown in FIGS. 5 and 6, respectively, in accordance with an exemplary embodiment of the present disclosure;

FIG. 7C is a block diagram of an example optimized OD²FA construction from the OD²FA construction shown in FIG. 7B in accordance with an exemplary embodiment of the present disclosure;

FIG. 8 is an example table showing overlay classifiers and their corresponding super-state transitions for the super-states in the OD²FA construction shown in FIG. 7C;

FIG. 9 is an example bit merging technique to minimize the overlay classifier example shown in FIG. 8 in accordance with an exemplary embodiment of the present disclosure;

FIG. 10A is an example block diagram of the D²FA for the RegEx /x.*y.*z/ and two possible overlay structures for the OD²FA in accordance with an exemplary embodiment of the present disclosure;

FIG. 10B is an example block diagram showing the resulting super-state of the merged OD²FA shown in FIG. 10A with and without padding, in accordance with an exemplary embodiment of the present disclosure;

FIG. 10C is an example block diagram of ternary content addressable memory (TCAM) predicate rule implementation for padded and unpadded minimized overlay classifiers in accordance with an exemplary embodiment of the present disclosure;

FIG. 11 is an example block diagram showing final TCAM and SRAM rule tables corresponding to the OD²FA construction shown in FIG. 7 for an identical RegCAM algorithm for the same RegEx set {/ab[̂n}*pq/ , /cd{̂n]*pr/} in accordance with an exemplary embodiment of the present disclosure;

FIG. 12A is block diagram showing a 1-stride table for an example super-state 0 self-loop unrolling example of the TCAM rules shown in FIG. 11 in accordance with an exemplary embodiment of the present disclosure;

FIG. 12B is block diagram showing a 3-stride table for an example super-state 0 self-loop unrolling example of the TCAM rules shown in FIG. 11 in accordance with an exemplary embodiment of the present disclosure;

FIG. 13 is block diagram showing variable stride transitions generated for super-state 0 from 1-stride transition in FIG. 8 in accordance with an exemplary embodiment of the present disclosure;

FIG. 14A is an example graph showing TCAM expansion factor (TEF) versus a non-deterministic finite (NFA) states of a RegEx set for OverlayCAM and RegCAM algorithms;

FIG. 14B is an example graph showing super-state expansion factor (SEF) versus non-deterministic finite (NFA) states of a RegEx set for an OverlayCAM algorithm;

FIG. 15 is an example block diagram of a packet inspection system 1500 in accordance with an exemplary embodiment of the disclosure;

FIG. 16 is a flow diagram of an example method 1600 in accordance with an embodiment of the present disclosure;

FIG. 17 is a flow diagram of an example method 1700 in accordance with an embodiment of the present disclosure;

FIG. 18 is a flow diagram of an example method 1800 in accordance with an embodiment of the present disclosure;

FIG. 19 is pseudo-code representation of an OD²FAMerge algorithm in accordance with an embodiment of the present disclosure;

FIG. 20 is pseudo-code representation of a DirectOD2FAMerge algorithm in accordance with an embodiment of the present disclosure;

FIG. 21 is pseudo-code representation of an algorithm for constructing overlay classifiers in accordance with an embodiment of the present disclosure;

FIG. 22 is pseudo-code representation of an algorithm for minimizing the overlay classifier in accordance with an embodiment of the present disclosure; and

FIG. 23 is pseudo-code representation of an algorithm for building the k-var-stride transition tables in accordance with an embodiment of the present disclosure.

### DETAILED DESCRIPTION

Throughout the disclosure, phrases are often used in first person (e.g., “we ______”) or presented as “in various embodiments,” or “various embodiments include”. In various embodiments of the present disclosure, the steps, acts, functions, methods, etc. explained in these statements may be performed automatically or semi-automatically by any suitable combination of hardware and/or software. For example, when implemented in hardware, the hardware may comprise one or more of discrete components, an integrated circuit, an ASIC, a programmable logic device (PLD), one or more processors, controllers, etc., that may execute instructions. Software implementations may include one or more algorithms or executable code, that when executed on a hardware device to accomplish the described function.

To address the limitations of prior DFA based automata, embodiments of the present disclosure include implementation of an overlay automata approach. In various embodiments, Overlay Deterministic Finite State Automata (ODFA) are utilized that model state replication in DFAs. In accordance with such embodiments, the DFA states that are replications of the same NFA state may be overlayed vertically together into a “super-state.” In this way, if a DFA is viewed as a 2-D object, then an ODFA can be viewed as a 3-D object.

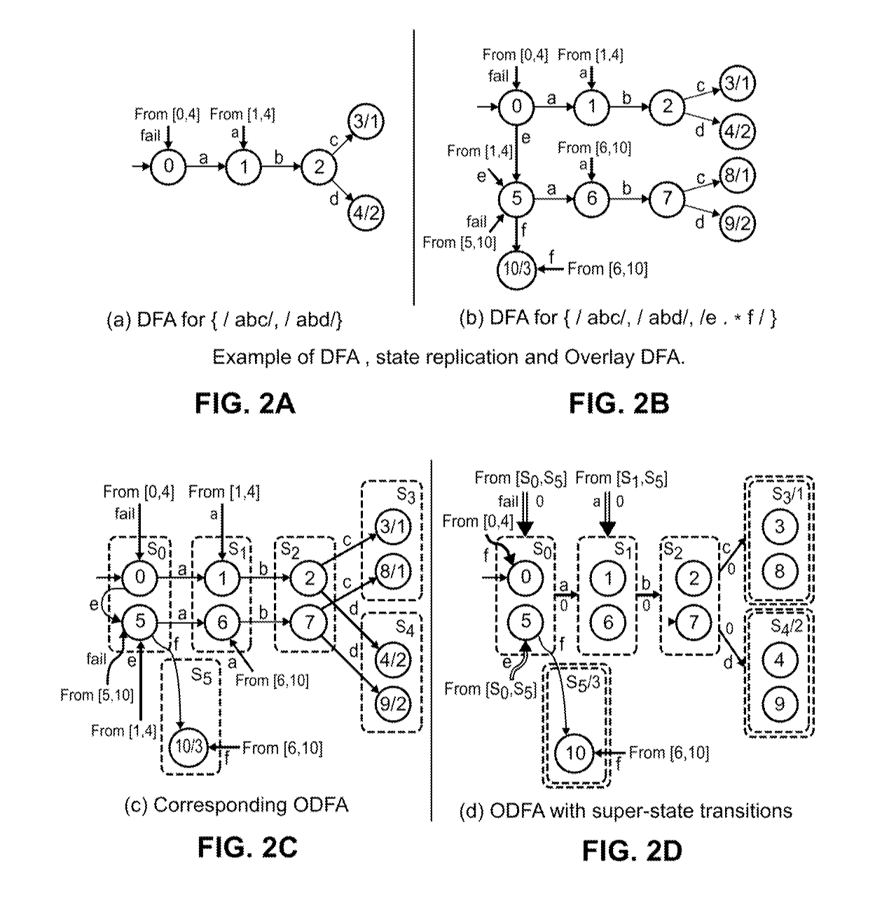

As will be further discussed below, FIG. 2 depicts the DFA and ODFA for the RegEx set {/abc/, /abd/, /e.*f/}. The ODFA model provides several benefits. First, it allows replications of the same NFA state to be compactly referenced using super-states. As shown in FIG. 2, for example, some states may be merged together to form one super-state, such as states 0 and 5, while other states may, such as states 1 and 6, may be merged to form other super-states, specifically super-states S0 and S1, respectively. Moreover, various embodiments allows replications of the same NFA transition to be compactly represented by one super-state transition between two super-states. As shown in FIG. 2, the two transitions from states 0 and 5 on character “a” are merged into one super-state transition on character “a.”

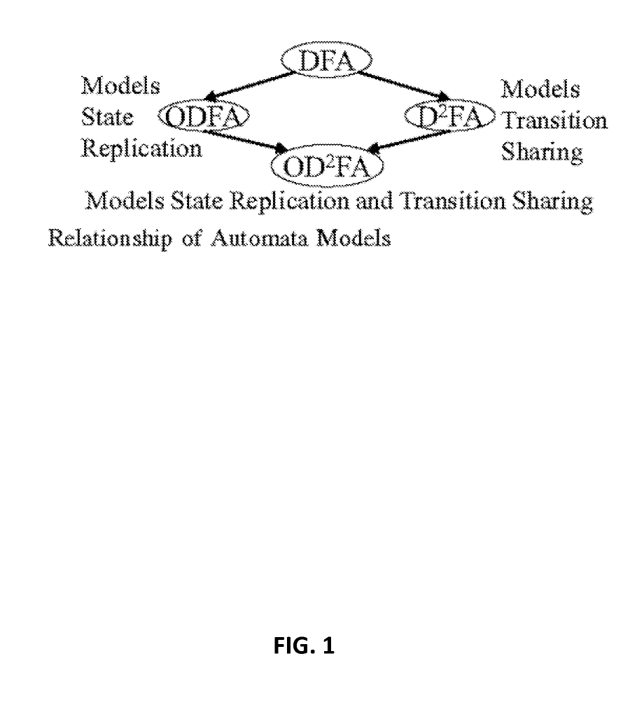

Second, combining the overlay idea, which models state replication and replicated transitions with the delayed input idea in D²FA, which models sharing non-replicated transitions among non-replicated DFA states through a state deferment relationship, various embodiments provide an Overlay Delayed Input DFA (OD²FA) to model state replication, replicated transitions, and transition sharing. The relationship among these automata models, DFA, D²FA, ODFA, and OD²FA, is illustrated in FIG. 1. A key benefit of OD²FA is that the deferment relationship among D2FA states may be represented more compactly using deferment among OD²FA super-states. From the perspective of transitions, OD²FA optimizes both deferred transitions (i.e., common transitions among states) and replicated transitions.

Third, various embodiments include an algorithm for constructing OD²FA from a given set of RegExes incrementally. In accordance with such embodiments, an equivalent OD²FA for each RegEx is generated. The OD²FAs are then merged efficiently until only a single, final OD²FA for the entire set of RegExes remains.

Fourth, various embodiments include applying what is termed herein “OverlayCAM,” which is an algorithm for implementing OD²FA in Ternary Content Addressable Memory (TCAM). TCAMs are typically implemented in off-the-shelf chips and have been widely deployed in modern networking devices; this means that deploying embodiments in most current core networking devices (such as NIDSes/NIPSes) does not require any architectural or hardware change.

A bit in TCAM may have three values: 0, 1, or *. For a TCAM of w-bit width, where w is configurable, and given a lookup key of w binary bits, the chip will compare the key with every TCAM entry in parallel and then report the index of the first TCAM entry that matches the key, where a ‘*’ can match both 0 and 1. This index may be used to retrieve the corresponding decision in the SRAM associated with the TCAM.

TCAM-based RegEx matching significantly outperforms prior software or FPGA based RegEx matching schemes. However, the key issue in TCAM-based RegEx matching is to reduce TCAM space, as TCAM chips have small capacities (maximum size on the order of 72 megabits as of this writing), consume a great deal of power, and generate a great deal of heat.

Based on OD²FA, various embodiments facilitate the OverlayCAM algorithm not only encoding multiple deferred transitions using one TCAM entry, but also encoding multiple non-deferred transitions that are replications of the same NFA transition using a single TCAM entry.

### I. Overlay Automata

In this section, we formally define Overlay DFA (ODFA) and Overlay D²FA (OD²FA). Table I, presented below, summarizes the notations used throughout this disclosure.

TABLE I
TABLE OF NOTATIONS.

| Notation | Meaning |
|---|---|
| D | A DFA/D²FA |
| [symbol] | An ODFA/OD²FA |
| Q | The set of states in a DFA/D²FA/ODFA/OD²FA |
| [symbol] | The set of super-states in an ODFA/OD²FA |
| [symbol] | The set of overlays an ODFA/OD²FA |
| s, q, o | A DFA/D²FA/ODFA/OD²FA state |
| S | An ODFA/OD²FA super-state |
| O | An ODFA/OD²FA overlay |
| X | A set of overlays in an ODFA/OD²FA |
| M(s) | Set of RegExes accepted by state [symbol] |
| [symbol] (S) | Set of RegExes accepted by all states in super-state S |
| F(s) | Defered state of state s |
| [symbol] (S) | Deferred super-state of super-state S |
| F⁻¹ (s) | The set of states that defer to state s |
| p→q | State p defers to state q |
| p→q | State p descendant of state q |
| ⊥ | NULL state/empty location |
| ρ(s, σ) | Partial state transition function for a D²FA |
| δ′(s, σ) | Total transaction function drived from ρ |
| Δ(S, X, σ) | Super-state transition function for a ODFA/OD²FA |
| ρ′(s, σ) | Partial state transition function derived from Δ |
| δ″(s, σ) | Total transaction function derived from Δ/ρ′ |

[symbol]

indicates data missing or illegible when filed

A. Overlay DFA

There are two ideas behind ODFA. The first is to group all DFA states that are replications of the same NFA state into a single super-state. The second is to merge as many transitions from the replicate states within a super-state as possible. To define ODFA, embodiments include the introduction of the concepts of super-states, overlays, and super-state transitions. Although the present embodiments may apply to any suitable number or RegExes, the following informal OFDA definition and examples refer to FIG. 2 as a running example.

FIG. 2A is a block diagram of an example DFA for a RegEx set {/abc/, /abd/} in accordance with an exemplary embodiment of the present disclosure. First, notation of defined for the DFA in FIG. 2A corresponding to the RegEx set {/abc/, /abd/}. To simplify the diagram, transitions that have a common destination state on common characters are condensed. These transitions are denoted with double arrows with their character labels next to the double arrow. The source states for these transitions are denoted as “From [x . . . y]” which represents the set of states with state IDs in the range [x . . . y].

For example, as shown in FIG. 2A, four transitions starting in states 1 through 4 that end in state 1 on character ‘a’ using double arrows beneath “From [1 . . . 4]” and an ‘a’ next to the double arrow. When the text next to a double arrow is “fail”, this represents all character transitions not explicitly shown in FIG. 2A. For example, the “fail” transition in FIG. 2A includes all transitions out of state 0 for characters that are not ‘a’. Finally, in an accepting state, the number following the ‘/’ represents the ID of the RegEx matched by that accepting state.

FIG. 2B is a block diagram of an example DFA for a RegEx set {/abc/, /abd/, /e.*f/} in accordance with an exemplary embodiment of the present disclosure. The DFA in FIG. 2B shows the DFA after the RegEx /e.*f/ is added. This DFA illustrates the potential for ODFA, as the entire DFA for the RegEx set {/abc/, /abd/} is replicated twice.

The corresponding ODFA is shown in FIG. 2C. FIG. 2C is a block diagram of an example overlayed DFA (ODFA) for the RegEx set shown in FIG. 2B having six super-states in accordance with an exemplary embodiment of the present disclosure. As shown in FIG. 2C, the two copies of the DFA for the RegEx set {/abc/, /abd/}) are overlaid on top of each other. In an embodiment, each pair of replicated DFA states may be considered a super-state in the ODFA. Each layer of states is called an overlay. The ODFA in FIG. 2C includes six super-states S0, . . . , S5 and two overlays. Each overlay contains a subset of the states in the entire DFA. As shown in FIG. 2C, the first overlay does not contain a state from super-state S5.

The concept of super-state transitions is now introduced. In an embodiment, one super-state transition may represent multiple DFA transitions as much as one super-state represents a group of DFA states. In a standard DFA transition, the source state is a DFA state. In a super-state transition, the source state is an ODFA super-state and represents transitions from all the replicated DFA states within the super-state. The destination state may include an ODFA super-state or a DFA state. The two super-state transition forms are

$${S}_{1} {\to }^{σ} {S}_{2} ,$$

o, 1 and

$${S}_{1} {\to }^{σ} {S}_{2} ,$$

O, 0 (distinguished by the last bit value 1/0).

In the first form, the semantics are that each DFA state q in super-state S₁ transitions on character σ to a DFA state q′ in super-state S₂, with o=(overlay of q′−overlay of q) mod #overlays. The value of o is usually 0. In the second form, the semantics are that each DFA state q in super-state S₁ transitions on character σ to the DFA state located in super-state S₂ at overlay O. For example, consider the two DFA transitions

$$1 {\to }^{b} 2 and 6 {\to }^{b} 7$$

in FIG. 2(c). These two transitions may be represented by one super-state transition

$${S}_{1} {\to }^{b} {S}_{2} ,$$

0, 1; the 0 denotes no change in overlay. As a second example, consider the two DFA transitions

$$3 {\to }^{e} 5 and 8 {\to }^{e} 5$$

in FIG. 2C. These two transitions may be represented by one super-state transition

$${S}_{3} {\to }^{e} {S}_{2} ,$$

1, 0.

To provide another example, one or more (or all) DFA transitions may be replaced by super-state transitions, which facilitates a reduction in the total number of transitions by the number of overlays in the ODFA. For some RegEx examples, not all states in a super-state have transitions that can be merged. Thus, embodiments include generalizing super-state transitions to provide super-state transitions to be defined for a specific set of overlays X within a given super-state. Technically, traditional transitions from a single state s are super-state transitions, where X contains only s's overlay. We refer to these as singleton super-state transitions.

FIG. 2D is a block diagram of an example overlayed DFA (ODFA) for the OFDA shown in FIG. 2C having super-state transitions in accordance with an exemplary embodiment of the present disclosure.

FIG. 2D shows the ODFA for our running example with non-singleton super-state transitions denoted with thick edges. For example, the two transitions

$$0 {\to }^{a} 1 and 5 {\to }^{a} 6$$

from FIG. 2(c) are represented with one super-state transition

$${S}_{0} {\to }^{a} {S}_{1} ,$$

0, 1. For super-state transitions of the form

$${S}_{1} {\to }^{σ} {S}_{2} ,$$

o, 1 (i.e. destination is also a super-state), the number σ besides the thick edge gives the change in overlay value o. As double arrows represent multiple transitions, thick double arrows represent multiple non-singleton super-state transitions.

For example, the two transitions

$$0 {\to }^{e} 5 and 5 {\to }^{e} 5$$

from FIG. 2C are included in one super-state e transition

$${S}_{0} {\to }^{e} {S}_{0} ,$$

1, 0 which is part of the thick double arrow labeled with “e” ending at state 5. The DFA in FIG. 2B has 11×256 =2816 total transitions; the ODFA in FIG. 2D has 1542 total super-state transitions which is close to the best possible result of 2816/2=1408 total super-state transitions; only a few of these transitions are singleton super-state transitions.

Although embodiments include defining an ODFA model with super-state transitions where the destination state is a super-state, practical implementation presents challenges as each DFA transition represented by such a super-state transition has a different destination DFA state. These challenges are addressed in several embodiments further discussed below to represent such super-state transitions using a single TCAM entry.

The formal definition of DFA is now introduced and used to formally define the ODFA. Given a set of RegExes [symbol] , a corresponding DFA is a 5-tuple (Q, Σ, q₀, M, δ) where Q is a set of states, Σ is an alphabet, q₀εQ is the starting state, M:Q→2^{R} gives the subset of RegExes accepted by each state, and δ:Q×E→Q is the transition function.

In a traditional DFA definition, rather than M, each state is simply an accepting or rejecting state. The language accepted by the DFA would simply be U_{rεR}L(r). However, in security settings where each regular expression corresponds to a unique threat, the system knows which regular expressions have been matched. Thus, M stores the subset of RegExes matched when each state is reached, and the language of strings accepted by each state q is U_{rεM(q)}L(r). For example, in FIG. 2B, the language of strings accepted by state 3 are those that end in /abc/which corresponds to RegEx 1, and the language of strings accepted by state 10 are those that end in /e.*f/ which corresponds to RegEx 3.

### Definition 1: Overlay DFA (ODFA)

In an embodiment, an Overlay DFA (ODFA) for a set of RegExes R may be defined as a 7-tuple (Q, Σ, q0, S, O, M, Δ). The first three terms are the same as those in the above DFA definition.

In an embodiment, the next two terms define the overlay structure on top of a DFA: S={S1, . . . , S|Σ|} is a set of super-states that partitions Q, while O={O₁, . . . , O_{|O|}} is a set of overlays that also partitions Q. Each overlay may be treated as a unique number in Δ. Overload notation is utilized to define S: Q→S and O: Q→O as functions mapping states to super-states and overlays, respectively. For any two states si≠sj, then (S(si), [symbol] (si))≠(S(sj), O(sj)). For any super-state S and overlay O, S∩O is either empty or contains one state SεQ.

The term M: S→2^{R} gives the subset of RegExes matched by any state within the given super-state. Of course, M is only correctly defined assuming Δ is correctly defined too. The final term Δ: S×2 [symbol] ×Σ→S×[0 . . . | [symbol] |×{0, 1} defines the super-state transition function. For any SεQ and any σεΣ, all the transition (S(s), X, σ) EΔ with [symbol] (s) E X have the same value; i.e. if we have two transitions (S(S), X, σ)ε Δ and (S(s), Y, σ) εΔ, with [symbol] (s)εX∩Y, then we have Δ(S(s), X, σ)=Δ(S(s), Y, σ).

δ″ (s, σ) may be defined based upon this unique transition value, say (S′, o, b) as follows. First, if b=0, the transition may be referred to as a non-offset transition, and δ″(s, σ)=S′∩o. Otherwise (b=1), the transition may be referred to as an offset transition, and δ″(s, σ)=S′∩(( [symbol] (s)+o) mod | [symbol] |). In this definition, we treat overlays as integers. Overlay (( [symbol] (s)+o) mod | [symbol] |) does intersect S′. Normally, for offset transitions, o=0, so the resulting overlay is [symbol] (s).

Even though embodiments of an ODFA model may include super-states and overlays, various embodiments include processing an input string in substantially the same manner as a DFA. That is, the ODFA is typically in a unique state and each character processed moves the ODFA model to a potentially new state. But the ODFA may compress multiple DFA transitions into a single ODFA super-state transition, and the RegEx matching information is stored at the super-state level rather than at the state level.

For example, using the ODFA model as shown in FIG. 2D and the input string “abea” as an example, the ODFA begins in state 0. After processing character a, the ODFA moves to state 1. After processing character b, the ODFA moves to state 2. After processing character e, the ODFA moves to state 5. Finally, after processing character a, the ODFA moves to state 6. In an embodiment, the first and fourth transitions are actually the same super-state transition. The third transition corresponds to the first form of super-state transition with specified destination state 5. Therefore, for these cases, M(S(s))=ø, so no RegEx is matched at any point in time.

Algorithms for constructing an ODFA from a given set of regular expressions are not shown for purposes of brevity. However, in various embodiments, these algorithms are subsumed by our construction algorithms for OD²FA, which are further discussed below.

Overlays and super-states may be represented as two orthogonal partitionings of states in Q; intuitively, super-states partition Q vertically and overlays partition Q horizontally. In various embodiments, any suitable number and type of state partitioning may be implemented to partition the states of a DFA into super-states and overlays. The benefits of an ODFA are realized by a careful partitioning; for example, grouping replicate states of the same NFA state together in a super-state. Note that some super-states may not have DFA states in each overlay. For example, as shown in FIG. 2D, super-state S5 contains one DFA state 10 which belongs to the second overlay.

In an embodiment, the compressive power of a super-state transition increases with the number of overlays that it includes. In a best case example, all overlays are included in a super-state transition. In FIG. 2D, most super-state transitions include all overlays, i.e., there are only a few singleton super-state transitions. In more complex ODFA, there may be cases where a given super-state transition includes more than one overlay but not all overlays.

Embodiments include generalizing the matching definition of ODFA to allow different states within a super-state to match different RegExes where the set of RegExes matched in state s is defined by M(s) U M(S(s)). However, in practice, this is typically not necessary. It is also impractical if each state requires its own set of matched RegExes, given state explosion. Thus, ODFA satisfies the following Condition (C1).

(C1)∀SεS, ∀s₁, s₂εS, M(s₁)=M(s₂)

### B. Overlay D²FA

ODFAs address state explosion and D²FAs address transition explosion. In various embodiments, overlay D²FAs (OD²FAs) may be implemented that address both state and transition explosion in DFAs. D²FA use default transitions to compactly represent many common transitions between states in a DFA transition function δ. For example, consider two DFA states s1 and s2 where δ(s1, σ)=δ(s2, σ) for all characters σεC⊂Σ. The DFA requires |Σ| transitions for both s1 and s2; the D²FA eliminates δ(s2, σ) for all σεC by adding a default transition from s2 to s1.

If the D²FA is in state s2 and receives a character σεC, the D²FA follows the default transition and changes to s1 without consuming σ; the D²FA will then process a correctly because δ(s1, σ)=δ(s2, σ). In this scenario, s2 defers to s1 and the default transition from s2 to s1 is called a deferment transition (or edge). In many cases, almost every state in a D²FA can eliminate all but one or two character transitions. For the above example, the D²FA eliminates |C| transitions at the cost at the cost of adding one deferment transition. In software implementations of D²FA, there is a time penalty as each deferment transition taken does not advance the processing of the input. In TCAM implementations of D²FA, however, there is no time penalty because of the first match functionality of TCAMs.

Given a DFA D=(Q, Σ, q0, M, δ), its corresponding D²FA, D′, is defined as a 6-tuple (Q, Σ, q0, M, ρ, F), where the combination of deferred state function F: Q→Q and partial function ρ: Q×Σ→Q is equivalent to DFA transition function δ. To make F a complete function, for a state s that does not defer to any other state, we have s defer to itself by setting F(s)=s. The deferment relationship among states defined by F forms a deferment forest. A D²FA is well defined if and only if there are no cycles other than self-loops in the deferment forest. The roots of the deferment trees in the forest are those states that defer to themselves. As a matter of notation, q→s denotes F(q)=s, i.e. q directly defers to s. q [symbol] s also denotes that there is a path from q to s in the deferment forest defined by F. How F and ρ combine to define δ is further described.

Let dom(ρ) denote the domain of partial function ρ, i.e. the values for which ρ is defined. The total transition function for a D²FA is defined as:

$${δ}^{′} ( s , σ ) = \{ \begin{matrix}ρ ( s , σ ) if 〈 s , σ 〉 ∈ dom ( ρ ) \\ {δ}^{′} ( F ( s ) , σ ) else\end{matrix}$$

To ensure δ′(s, σ) is appropriately defined for all SεQ and σεΣ, the following conditions are satisfied. For any (s, σ)ε dom(ρ), ρ(s, σ)=δ(s, σ). Furthermore, ∀ [symbol] s, σ [symbol] εQ×Σ, [symbol] s, σ [symbol] εdom(σ) if (F(s)=sv δ(s, σ)≠δ(F(s), σ)).

Next, we formally define the OD²FA.

### Definition 2: Overlay D²FA (OD²FA)

In an embodiment, an OD²FA may be defined as an 8-tuple (Q, Σ, q0, F, S, O, M, Δ), where the first three terms are same as in defining D²FA, and the last four terms are the same as in defining ODFA. In an embodiment, a partial transition function ρ′: Q×Σ→Q is derived from Δ. Since ρ′ is a partial function, the existence of a transition for each (s, σ) in Δ is unnecessary. Furthermore, F: S→S represents the super-state deferment function, and gives the deferred super-state for each super-state. Further in accordance with such embodiments, the D²FA state deferment function F may be defined from F as F(s)=F(S(s)) ∩ O(s)). To ensure this is a valid deferment function, F satisfies the following two conditions. First,

(C2)∀s εQ, F(S(s))∩O(s))≠⊥,

Second, the deferment forest of super-states defined by F has no cycles other than self-loops. Finally, ρ′ and F define a total transition function δ″ as follows:

$${δ}^{″} ( s , σ ) = \{ \begin{matrix}{ρ}^{′} ( s , σ ) if 〈 s , σ 〉 ∈ dom ( {ρ}^{′} ) \\ {δ}^{″} ( F ( s ) , σ ) else\end{matrix}$$

In an embodiment, [symbol] s, σ [symbol] εdom(ρ′) if there exists a transition (S(s), X, σ)εΔ with O(s)εX. ρ′(s,σ) if [symbol] s, σ [symbol] ε dom(ρ′), then ρ′(s, σ) is defined as δ″ is defined for ODFA.

Further in accordance with such an embodiment, the super-state S overlay covers super-state S′if ∀OεO, (S∩O=⊥)→(S′∩O=⊥). That is, every overlay that is empty in S is also empty in S′. Then, Condition (C2) provides that for every super-state S, super-state F(S) overlay covers S.

In an embodiment, transition function δ″ may be computed by finding a unique transition (S(s), X, δ)εΔΔ with O(s)εX, if such a transition exists. If not, the OD²FA follows the super-state deferment function. In the software implementation further discussed below, performing these checks may incur a time penalty. However, in embodiments using TCAM implementation as further discussed below, these checks may be performed with no such penalty.

As defined, we store F (i.e., as defined above in the 8 tuple equation, for example) rather than F. As a result, embodiments include deferment information being stored at the super-state level Likewise, embodiments include storing RegEx matching information M at the super-state level. Finally, with Δ, many super-state transitions represent multiple singleton transitions. Combined, this may provide significant savings.

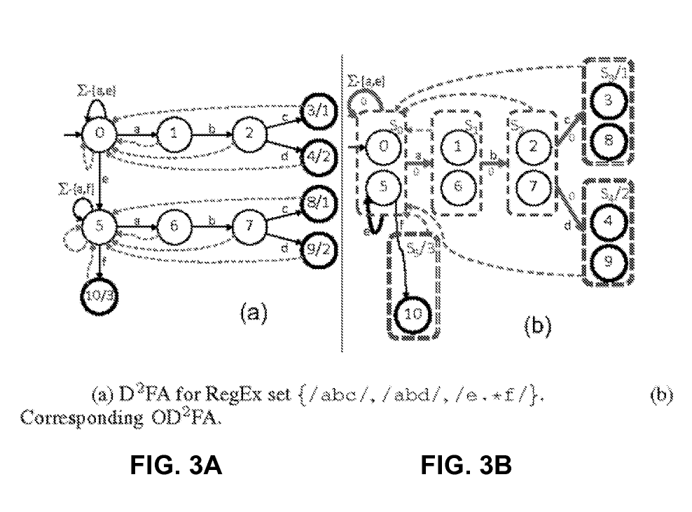

FIG. 3A is a block diagram of an example D²FA for a RegEx set {/abc/, /abd/, /e.*f/} in accordance with an exemplary embodiment of the present disclosure. FIG. 3A shows the D²FA for the RegEx set {/abc/, /abd/, /e.*f/}. The dashed edges are deferment transitions.

FIG. 3B is a block diagram of an example OD²FA for the RegEx set shown in FIG. 3A in accordance with an exemplary embodiment of the present disclosure. FIG. 3B shows the corresponding OD²FA. Using the examples shown in FIGS. 3A and 3B, the D²FA needs to store 518 actual transitions and 10 deferment transitions, while the OD²FA only needs to store 260 actual transitions, most of which are not singleton super-state transitions, and 5 super-state deferred transitions. For this example, near optimal compression is achieved given two overlays in the OD²FA when compared to the D2FA.

### C. OD²FA Multiplicative Compression

In various embodiments, OD²FA may multiply the compressive effect of D²FA and ODFA to significantly reduce the space required to store transitions. Again, ODFA reduces the storage space for transitions among DFA replicates by storing one super-state transition for each replicated transition. The compression limit for ODFA is the number of DFA replicates. Furthermore, D²FA reduces the storage space for transitions within each DFA replicate using deferment transitions. The compression limit for D²FA is the number of states within each DFA replicate. In an embodiment, OD²FA may perform both simultaneously. The compression limit is the number of DFA replicates multiplied by the number of states within each replicate, which is essentially the total number of DFA states.

To illustrate this multiplicative compression, consider again the OD²FA in FIG. 3B. The original DFA for this RegEx set requires 11×256=2816 transitions. The corresponding ODFA in FIG. 2D is able to reduce the number of transitions by almost a factor of 2 by storing one super-state transition for each pair of replicated transitions. The corresponding D²FA in FIG. 3A reduces the number of transitions by more than a factor of 5 using deferment transitions. In particular, in both replicates, almost all of the transitions for all states except the self-looping start states are eliminated. Finally, the OD²FA in FIG. 3B multiplies both effects and ends up with 260 super-state transitions and 5 super-state deferment transitions. This is almost a factor of 11 times smaller than the original DFA, where 11 is the compression limit since the DFA has 11 states. Starting from the D²FA, the OD²FA is able to replicate all the self-looping transitions out of the two self-looping states in the D²FA (adding one singleton transition on ‘f’ for state 5). This is critical since the vast majority of transitions remaining in many D²FA are self-looping transitions.

### II. OD²FA Construction

Given a set of RegExes, various embodiments include constructing its equivalent OD²FA incrementally in two phases. In the first phase, an equivalent individual OD²FA may be constructed for each RegEx. In the second phase, each of the individual OD²FAs may be merged in a binary tree fashion; i.e., two OD²FAs may be merged into one OD²FA at a time until there is only one OD²FA for the entire given RegEx set.

In an embodiment, constructing an OD²FA involves three main steps: (1) creating the super-states (i.e. assigning a super-state, overlay pair for each DFA state), (2) setting the deferment for each super-state and (3) for each super-state creating the (combined) super-state transitions from the (singleton) state transitions. In various embodiments, the algorithms for the first two steps (creating super-states and setting deferment) are different for the two phases mentioned above, while the algorithms for the third step (creating super-state transitions) are substantially identical for the two phases. The OD²FA construction algorithms are described in two parts. This section is explains how super-states are created and how super-state deferment is set (i.e. steps 1 and 2) during both phases. The following section B explains how super-state transitions are built from state transitions (i.e. step 3).

A. D²FA Construction from One RegEx

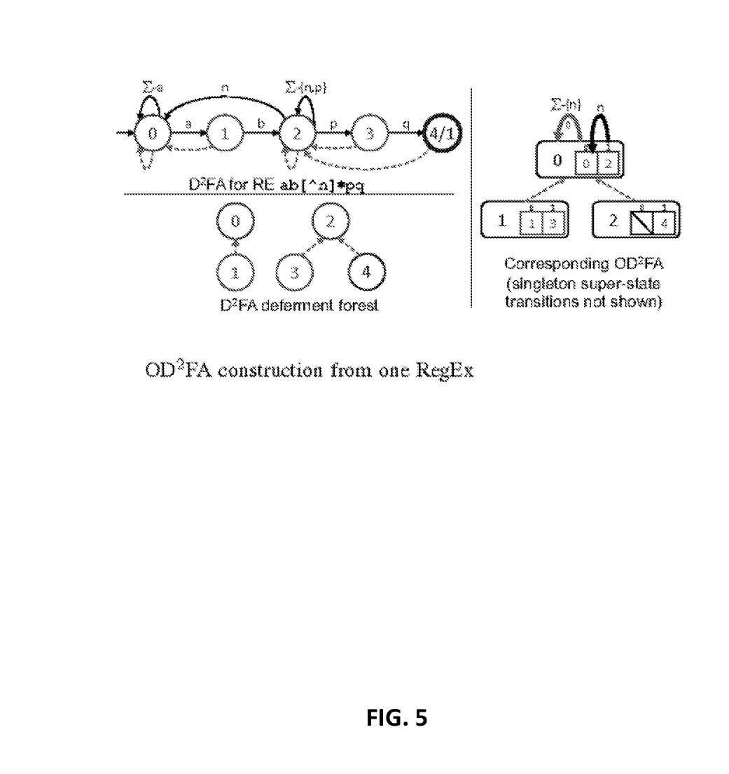

In an embodiment, given one RegEx, its equivalent D²FA is built. In various embodiments, an equivalent D²FA model for one RegEx may be built using any suitable techniques. The deferment relationship among states in the D²FA defines a deferment forest. The root states in this forest are all self-looping states which means they transit to themselves for more than|Σ|/2=128 characters. Most failure transitions end in self-looping states. For example, in the D²FA in FIG. 5, states 0 and 2 are self-looping states.

Once the D²FA model is constructed, each self-looping state in the DFA is the root of a tree in the deferment forest of the D²FA, and vice versa. Furthermore, all the states whose failure transitions go to a self-looping state s are in the deferment tree rooted at s.

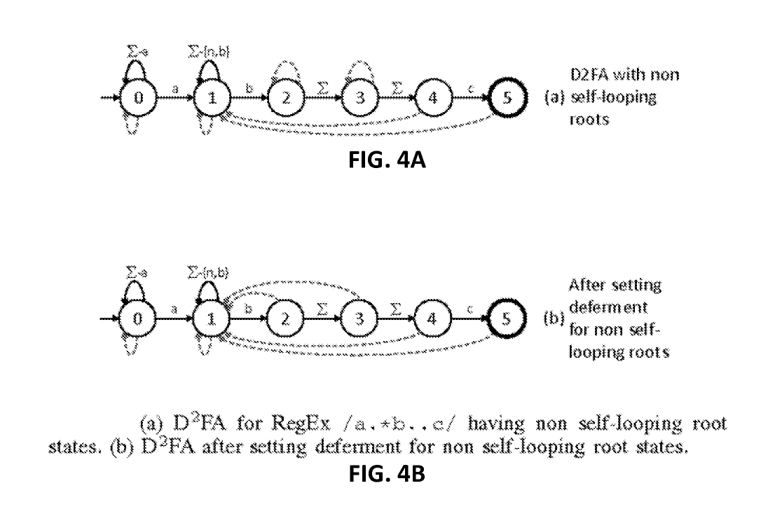

An exception to this property which creates non-self-looping root states relates to RegExes that have a ‘.’ (or a large range like [̂a]) without the closure ‘*’. FIG. 4A is a block diagram of an example D²FA for the RegEx /a.*b..c/ having non self-looping roots in accordance with an exemplary embodiment of the present disclosure.

For example, consider that D²FA shown in FIG. 4A for the RegEx /a.*b..c/. The deferment forest will have 4 root states, 0, 1, 2 and 3. States 0 and 1 are self-looping. However, states 2 and 3 are not self-looping and are only roots states because they have no transition in common with other states. In such cases, embodiments include making these states non root states and setting their deferment as follows.

It is identified where the deferment of the next state where the transition on the ‘.’ goes to. If there is more than one consecutive ‘.’, the state where the last ‘.’ transitions to is noted. In this example, the next state of the last ‘.’ is state 4. Thus, the deferment of this state may be followed until we reach its root, and select that root as the deferred state of the non self-looping roots. Continuing this example, the deferment chain of state 4 ends in state 1, so state 1 is chosen as the deferred state for both states 2 and 3.

Setting the deferment of non self-looping roots in this manner does not reduce the size of the D²FA, since these states will not have any transitions (or very few transitions) in common with their deferred states. However, this results in a better structure of the deferment forest. It also ensures we have the condition that all roots states are self-looping states and vice versa.

B. OD²FA Construction from One RegEx

FIG. 5 is a block diagram of an example OD²FA construction corresponding to a RegEx /ab[̂n]*pq/ in accordance with an exemplary embodiment of the present disclosure. In an embodiment, an algorithm may be utilized for constructing the OD²FA from a D²FA using the example in FIG. 5 for the RegEx /ab[̂n]*pq/.

Any D²FA is also a valid OD²FA with only a single overlay, singleton super-states, and singleton super-state transitions. Thus, as the D²FA is converted into a more compact OD²FA, the algorithm first creates valid overlays and super-states, and then updates the super-state transition function to combine multiple transitions into one super-state transition.

In various embodiments, the number of deferment trees in the super-state deferment forest is specified along with the number of overlays in a super-state. This may be accomplished, for example, by partitioning the self-looping root states of the D²FA into two groups: accepting root states and rejecting root states. If either partition is empty, embodiments include create one deferment tree in the OD²FA. Otherwise, there are two deferment trees. In an embodiment, the number of overlays in the OD²FA is the larger of the number of accepting root states and the number of rejecting root states. For a non-empty partition, embodiments include merging the root states in that partition into a single root super-state in the OD²FA. Typically, self-looping states are failure states, so the accepting root state partition is empty and the resulting root super-state is not formed. Thus, the deferment forest of the OD²FA typically has one deferment tree rooted at the rejecting root super-state. For example, the OD²FA in FIG. 5 has one deferment tree with two overlays, 0 and 1, and the rejecting root super-state is 0 2.

There are two reasons root states are grouped into super-states even though the self-looping states in the D²FA are usually not replications of the same NFA state. First, the common self-loops may be merged into super-state transitions, which is specified more precisely at the end of this subsection. Second, as self-looping states are typically the “replication points” when combining RegExes, grouping self-looping states into a common super-state facilitates the automatic identification of the state replications and replicated transitions when two OD²FA are merged, which is also elaborated further below. Condition (C2) is satisfied as the root super-state defers to itself.

In an embodiment, the remaining states are assigned to super-states and overlays ensuring Condition (C2) is maintained. Given a super-state S that is in the OD²FA deferment forest, embodiments include the OD²FA construction algorithm grouping the children of the states in S into new super-states that defer to S. This grouping may be recursively applied to the new super-states formed until all states are assigned to super-states.

Furthermore, embodiments include the children of the states of S being grouped into super-states. For example, let n be the number of non-empty overlays in S, and let S₁, . . . , sₙ be the states in these overlays. Furthermore, let Ci=F⁻¹ (si) be the set of children for each state si in S, and let U=∪ᵢ₌₁ⁿ Ci be the total set of states to be grouped into super-states. To ensure all states in a super-state match the same RegExes, U may be partitioned into accepting states and rejecting states and work with each partition independently. Without loss of generality, we assume U has one partition. Super-states are created with the following two goals in mind: grouping together states uεU from different Ci (1) to maximize the number of super-state transitions that can be formed, and (2) to minimize the total number of super-states formed.

For example, using a starting arbitrary state u from the first non-empty Ci u may be removed from Ci to create super-state S′ with just u in O(si). State uk has at least one common non-deferred transition with u to be selected. This process may be repeated until all the Ci are empty. Condition (C2) is maintained because a state s′ in a super-state S′ is added to overlay O if and only if the corresponding state s in F(S) is in overlay O. Using the D²FA in FIG. 5 with root super-state [0 2] as S, this provides C₀={1} and C₁={3, 4}, and three super-states, [1 ⊥], [⊥3], and [⊥4] are created, each of which defers to [0 2]. No super-states with more than one overlay occupied are formed because states 1 and 3 as well as 1 and 4 do not have any common non-deferred transitions.

After the super-states have been created, embodiments include merging together compatible pairs of super-states. In accordance with such embodiments, two super-states may be considered compatible if there is no overlay that is non-empty in both super-states. Using the example shown in FIG. 5, the super-states [1 ⊥] and [⊥3] may be merged together, providing two final super-states [1 3], and [⊥4].

Further in accordance with such embodiments, the last step is to create the super-state transitions, which is discussed further below.

It should be noted that merging super-states together does not have much effect on overall compression because most compression opportunities are accidental; they are not the result of replications of the same NFA state. The key compression that is attained results from grouping the root states together and combining the resulting self-loops into super-state transitions.

C. OD²FA Construction from 2 OD²FAs

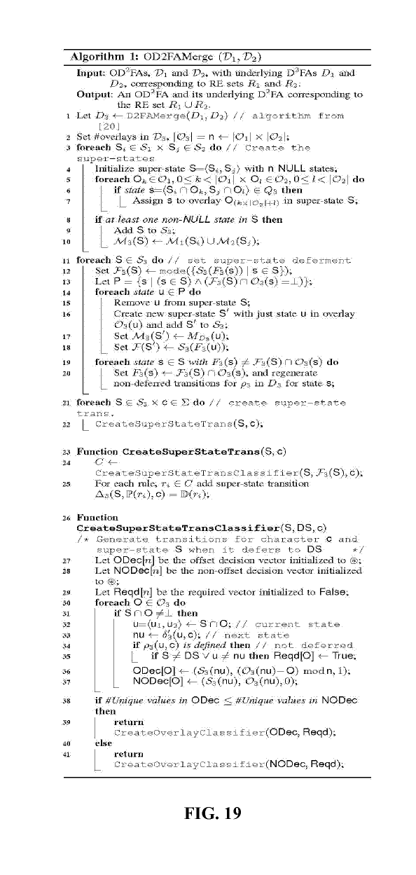

In an embodiment, an OD²FA merge algorithm OD²FAMerge is provided that constructs OD²FA D₃ with underlying D²FA D₃ for the RegEx set R₃=R₁∪R₂ given two OD²FAs, D₁ with underlying D²FA D₁ for RegEx set R₁ and D₂ with underlying D²FA D₂ for RegEx set R₂, where R₁ ∩R₂=ø. Pseudo-code for an exemplary OD²FAMerge algorithm, in accordance with an exemplary embodiment, is shown as Algorithm 1 in FIG. 19.

In an embodiment, the first step of the OD²FAMerge algorithm may include creating the merged D²FA D₃. As will be appreciated by those of ordinary skill in the art, any suitable space efficient D²FA merge algorithm may be implemented to facilitate this task. For example, a merge algorithm may be implemented that extends the standard Union Cross Product (UCP) construction algorithm for merging DFAs.

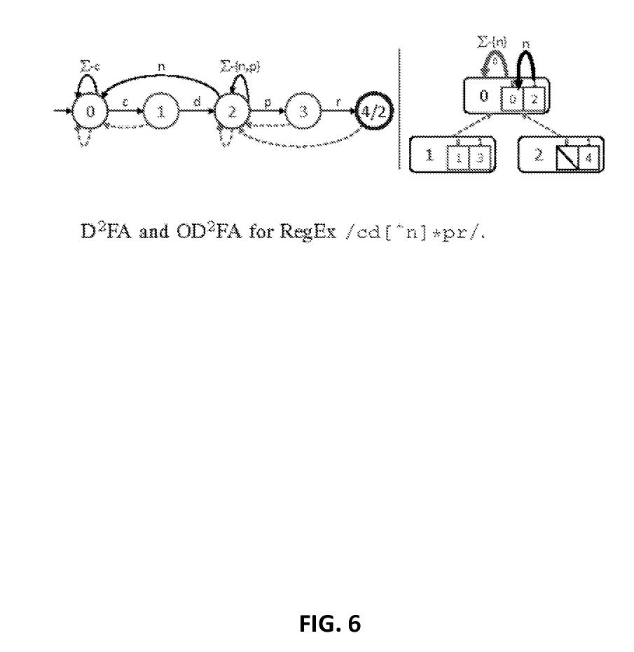

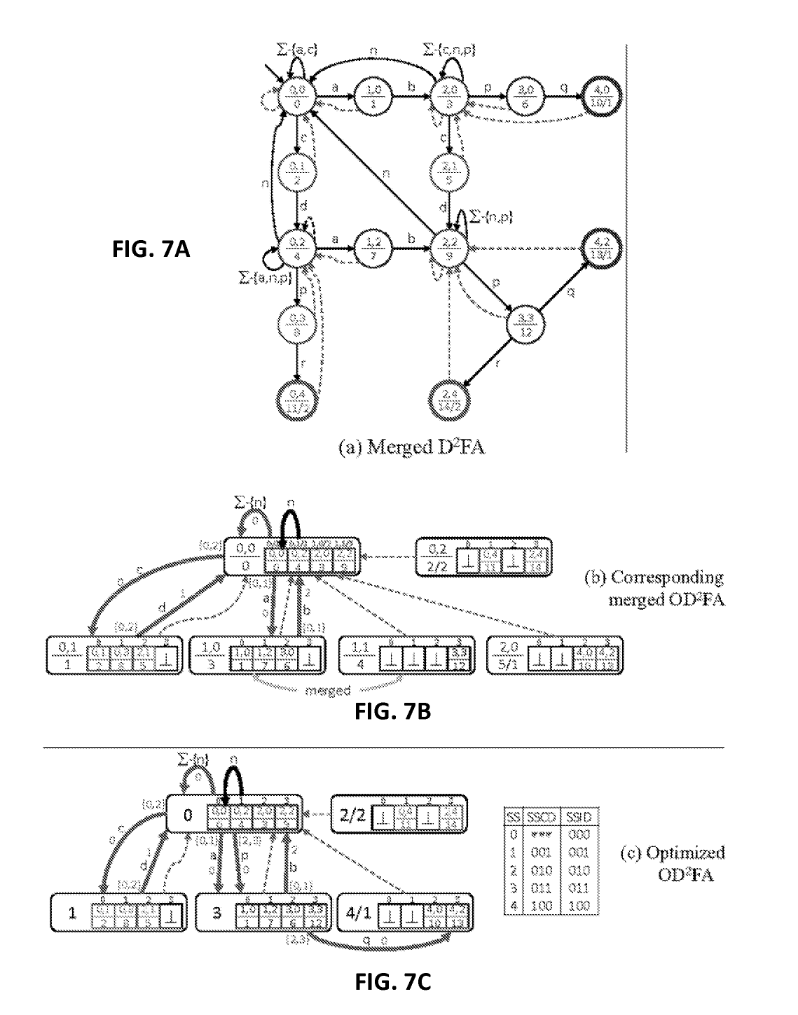

FIG. 7A is a block diagram of an example merged D²FA construction from the two D²FAs shown in FIGS. 5 and 6, respectively, in accordance with an exemplary embodiment of the present disclosure. For each state shown in FIG. 7A, the number below the line is the state id in D₃ and the two numbers above the line are the state ids of the states in D₁ and D₂ that this state corresponds to.

Further in accordance with this embodiment, the OD²FAMerge algorithm may include constructing OD²FA D3=(Q₃, Σ, q0₃, F₃, S₃, O₃, M₃, Δ₃) from the input OD²FAs D1=(Q₁, Σ, q0₁, F₁, S₁, O₁, M₁, Δ₁) and D2=(Q₂, Σ, q0₂, F₂, S₂, O₂, M₂, Δ₂) as well as the merged D²FA D3. The first three terms may be derived from D3. Then, the OD²FAMerge algorithm may set S3=S1×S2 and O3=O1×O2 and reduce S₃ to only include reachable super-states (e.g., a super-state that contains at least one reachable state). How the OD²FAMerge algorithm handles empty overlays is further discussed below. Thus, for any super-state S3= [symbol] S₁, S₂ [symbol] εS₃, we set M₃(S₃)=M₁(S₁)∪M₂(S₂).

FIG. 7B is a block diagram of an example merged OD²FA construction from the two OD²FAs shown in FIGS. 5 and 6, respectively, in accordance with an exemplary embodiment of the present disclosure.

As shown in FIG. 7B, for each super-state, the number below the line is the super-state ID in D3 and the pair numbers above the line are the super-state IDs of the super-states in D1 and D2 that this super-state corresponds to. For instance, consider state 7 in D3, which corresponds to state 1 in D1 and state 2 in D2. As shown in FIGS. 5 and 6, state 1 εD1 belongs to super-state 1 and overlay 0, and state 2εD2 belongs super-state 0 and overlay 1. Therefore, in OD²FA D3, the OD²FAMerge algorithm assigns state 7 to super-state 3, which corresponds to super-state 1 from D1 and super-state 0 from D2; similarly, the OD²FAMerge algorithm assigns state 7 to overlay 1, which corresponds to overlay 0 from D1 and overlay 1 from D2. As shown in FIG. 7B, the input character and overlay offset are shown along each super-state transition. For super-state transitions that do not include all the overlays in the super-state, the set of numbers at the base of the transition gives the included overlays.

In an embodiment, a super-state deferment relationship F₃ is defined as follows: for any super-state S, which contains one or more states in Q₃, we defer it to the super-state that contains most of the states that the states in S defer to; i.e., ∀SεS, F₃(S):=mode({S₃(F₃(u))|uεS}), where mode is the function that returns the most common item in a given multi-set.

Once F₃ has been defined, embodiments include adjusting the deferment relationship F for D²FA D₃. Specifically, for each state s in a super-state S where S defers to super-state S′, s defers to state s′ in S′ where s and s′ are in the same overlay if s′≠⊥. If s′=⊥, S is split into two super-states S₁=S\{s} and S₂={s}, where S₂ defers to the super-state that contains the state that s defers to (i.e., F₃ (S₂):=S₃ (F₃ (s))). Note that the case that s′=⊥ rarely happens in practice with RegEx sets. This super-state splitting ensures that Condition (C2) holds for D₃.

How the super-state transitions are created for the merged OD²FA is further discussed below.

An example of optimization for D3 is provided below. Among the super-states that defer to the same super-state, the OD²FAMerge algorithm merges two compatible super-states into one super-state if merging them results in more super-state transitions. This will commonly be the case when a D²FA state is lost that is expected to be generated from a self-looping state.

For example, as shown in FIG. 7A, the expected states [symbol] 2, 3 [symbol] and [symbol] 3, 2 [symbol] were lost, providing instead state 12 = [symbol] 3, 3 [symbol] . As a result, in FIG. 7B, the super-states 1₃=[2 8 5 ⊥] and 3₃=[1 7 6 ⊥] have ⊥ in overlay 3, and there is the super-state 4₃=[⊥⊥⊥12] with just state 12 in overlay 3, and super-state 4₃ is compatible with both super-states 1₃ and 3₃. In an embodiment, the OD²FAMerge algorithm may create new super-state transitions by merging super-state 4₃ with either 1₃ or 3₃.

FIG. 7C is a block diagram of an example optimized OD²FA construction from the OD²FA construction shown in FIG. 7B in accordance with an exemplary embodiment of the present disclosure. That is, FIG. 7C shows the resulting OD²FA when 4₃ from FIG. 7B is merged with 3₃, adding the super-state transitions out of super-state 0₃on ‘p’ to super-state 3₃ for overlays 2 and 3 with offset o=0 and the super-state transitions out of super-state 3₃ to super-state 5₃ (renamed 4₃ in FIG. 7C) on ‘q’ for overlays 2 and 3 with offset o=0.

Alternatively, the OD²FAMerge algorithm may merge super-state 4₃ from FIG. 7B with super-state 1₃ and added a super-state transition out of super-state 0₃ on ‘p’ to super-state 1₃ for overlays 1 and 3 with offset o=0 and a super-state transition out of super-state 1₃ on r to super-state 2₃ for overlays 1 and 3 with offset o=0. After merging super-states, the OD²FAMerge algorithm may regenerate the super-state transitions for all the super-states and not just the super-states that were merged, as merging super-states could lead to additional transition merging opportunities in other super-states as well.

Theorem 4.1: Given as input OD²FAs D₁ and D₂ and corresponding equivalent D²FAs D₁ and D₂ for RegEx sets R₁ and R₂, the OD2FAMerge algorithm outputs an OD²FA D₃ that is equivalent to D²FA D₃ for RegEx set R₁ U R₂.

Proof: The D²FA D₃ constructed by merging D²FAs D₁ and D₂ using D₂FAMerge algorithm is equivalent to RegEx set R₁∪R₂.

The generated OD²FA D₃ is equivalent to D²FA D₃. To demonstrate equivalence, we need to show that for each state sεQ3, the deferred state for s, the non-deferred transitions for s, and the matched RegExes for s, derived from D₃ are same as in D₃. Let s= [symbol] S₁, S₂ [symbol] εQ₃ be any state in D₃. First, S₃ (s) and [symbol] ₃ (s) are defined as we take a complete cross product of S₁×S₂ and [symbol] ₁× [symbol] ₂. The super-state transitions are directly generated from the D²FA state transitions. It is easy to see that ∀σεΣ, ρ′₃(s, σ) is defined in D₃ [symbol] [symbol] ρ₃ (s, σ) is defined in D₃; and when defined ρ′₃(s, σ)=ρ₃(s, σ).

Then we have the following two cases.

Case 1: S₃(s) added to S₃ on line 16. Then RegExes matched in D₃ by s=MD₃(s) ∪ M₃(S(s))=MD₃ (s) (∵MD₃(s)=ø). Deferred state of s in D₃=F₃(S₃(s)) ∩ [symbol] ₃(s)=S₃(F3(s)) ∩ [symbol] ₃(F₃(s))=F₃ (s).

Case 2: S₃(s) added on line 9. Then let S₃(s)=S= [symbol] S₁, S₂

[symbol]

RegExes matched in D₃ by s=MD₃(s)∪M₃(S)=M1(S₁)∪M2(S₂)=MD1 (s₁) ∪ MD₂(s₂)=MD₃(s). Deferred state of s in D₃=F₃(S)∩ [symbol] ₃(s)=F₃(s).

D. Direct OD²FA Construction from 2 OD²FAs

In an embodiment, our previously discussed OD²FA merge algorithm may cause a processor to store data representative of the underlying D²FA model along with the OD²FA model. In such an embodiment, the underlying D²FA requirement for merging OD²FAs may create two issues. First, in most practical cases, the RegEx set should be updated over time. If the underlying D²FA is discarded, then when a new RegEx is added to the RegEx set, the OD2FAMerge algorithm may not be able to merge the OD²FA for the new RegEx into the existing OD²FA. This would result in having to construct the entire OD²FA again, thereby defeating one of the main advantages of the merge approach to building the OD²FA, which is automatic support for updating the RegEx set.

Second, because the underlying D²FA is generally orders of magnitude larger than the OD²FA, the size of the D²FA may act to limit the scalability of the OD2FAMerge algorithm.

Therefore, in an embodiment, a DirectOD2FAMerge algorithm merges two OD²FAs without requiring a process to store the underlying D²FA model data. In accordance with such an embodiment, after the initial OD²FAs have been built for each individual RegEx, the DirectOD2FAMerge algorithm cause a processor to store the OD²FA at each merge step.

In an embedment, the DirectOD2FAMerge algorithm input is two OD²FAs, D₁=(Q₁, Σ, q₀₁, F₁, S₁, [symbol] ₁, M₁, Δ₁) for RegEx set R₁ and D₂=(Q₂, Σ, q₀₂, F₂, S₂, [symbol] ₂, M₂, Δ₂) for RegEx set R₂ where R₁∩R₂=ø, and we construct OD²FA D₃=(Q₃, Σ, q₀₃, F₃, S₃, [symbol] ₃, M₃, Δ₃) for the RegEx set R₃=R₁∪R2.

Just as in our OD²FAMerge algorithm as previously discussed, various embodiments of the DirectOD2FAMerge algorithm include each state (super-state) in D3 corresponding to a pair of states (super-states) from D₁ and D₂. In an embodiment, the DirectOD2FAMerge algorithm step performs a first step of computing Q₃, i.e. identifying which states in the underlying DFA for D₃ will be reachable. The set Q₃ may not be stored explicitly, but is implicitly stored from the set of non-empty overlays for each super-state. If the set of non-empty overlays for each super-state are stored as a list, the total size will be proportional to Q₃, which may be very large. Therefore, the DirectOD2FAMerge algorithm may cause a set of non-empty overlays for each super-state to be stored in a memory as a ternary classifier (similar to how we store super-state transitions as previously discussed).

In an embodiment, the DirectOD2FAMerge algorithm simulates a UCP to find the reachable states construction of the underlying DFAs of D₁ and D₂. That is, UCP construction is performed, but after computing the transitions of each merged state, which are not stored. The UCP construction also gives the state to super-states and overlay assignment. However, the queue of unexplored states while doing the UCP construction may be proportional to |Q₃|.

To avoid this, in an embodiment, the UCP construction is simulated by focusing on super-states instead of states. For example, for each discovered super-state in D₃, two sets of overlays are maintained: (1) the Explored set containing the overlays which have a reachable DFA state that have already been explored, and (2) the Unexplored set containing the overlays which have a reachable DFA state that have not already been explored. In addition, a queue, Queue, is maintained of super-states in D₃ that currently need to be explored, and the DirectOD2FAMerge algorithm causes a processor to explore one super-state from the queue at a time. For the super-state, say S, currently being explored, the DirectOD2FAMerge causes a processor to explore all the states corresponding to the overlays in S's Unexplored set, and move all the overlays from the Unexplored to the Explored set.

When a new state, say (S′∩O′), is discovered, DirectOD2FAMerge algorithm causes the new states to be processed as follows. If S′ is a newly discovered super-state, it is added to Queue and Explored(S′) is set equal to ø, and Unexplored(S′) is set equal to O′. Otherwise S′ is already discovered, and so is in S3. In this case, if O′ε Explored(S′) or O′ε Unexplored(S′), then no steps need to be executed as the state has already been discovered. Otherwise, this is a newly discovered state, so O′ is added to Unexplored(S′), and S′ is added to Queue if S′ is not already present.

In an embodiment, a super-state may be added to Queue and explored multiple times because all non-empty overlays within a super-state are not discovered at the same time. As mentioned earlier, the Explored and Unexplored overlay sets are maintained as ternary classifiers. As new overlays are added to the sets, the classifiers are minimized using the bit merging algorithm that is further discussed below.

After computing the reachable states, all the terms in D₃ have been constructed except for F₃ and Δ₃.

For the OD²FAs in FIG. 5 and FIG. 6, the DirectOD2FAMerge algorithm results in the same OD²FA as earlier shown in FIG. 7B.

As will be appreciated by those of ordinary skill in the art, any suitable techniques may be utilized to set the super-state deferment, which may include setting state deferment when merging D²FAs. For example, let [symbol] S₀, T₀ [symbol] S₀ be the current super-state in D₃ for which the deferment is to be computed. Let S₀→S₁→ . . . →Sₗ be the maximal deferment chain DC₁ (i.e. Sₗ is the root super-state) in D1 starting at S₀, and T₀→T₁→ . . . →Tₘ be the maximal deferment chain DC₂ in D₂ starting at T₀. We will choose some super-state (Sᵢ, Tⱼ) where 0≦i≦1 and 0≦j≦m to be F₃(S). In an embodiment, only a candidate super-state pair is considered if it is reachable in D₃ and its overlay covers super-state S (so Condition (C2) holds). Ideally, i and j should be as small as possible, as long as both are not 0. For example, good choices are typically (S₀, T₁) or (S₁, T₀). However, it is possible that both super-states are not eligible (either not reachable or do not overlay cover S). This leads us to consider other possible (Sᵢ, Tⱼ).

In an embodiment, for any candidate super-state pair (Sᵢ, Tⱼ) the super-state transitions may be built for super-state S as if it were to defer to super-state (Sᵢ, Tⱼ) in D₃ (we show details regarding how to build the super-state transitions below). The number of super-state transitions built provides a measure of the effectiveness of the deferment. That is, the fewer transitions built, the better it is. In an embodiment, the best match method may be utilized to consider all candidate super-state pairs, picking the one that results in the fewest super-state transitions built for super-state S.

In another embodiment, a faster strategy (the first match method) may be utilized to consider a ‘distance sum’ z=i+j in increasing order, from 1 to l+m. For the current distance sum z, all super-state pairs at that distance may be considered; i.e. the set of super-states Z={ [symbol] Sᵢ, T_{z-i} [symbol] |(max(0, z-m)≦i≦min(l, z))Λ( [symbol] Sᵢ, T_{z-i} [symbol] εQ₃)Λ [symbol] Sᵢ, T_{z-i} [symbol] overlay covers S)}. From the set of super-states Z, the super-state that results in the fewest super-state transitions built for super-state S is then selected. Thus, an eligible super-state may be identified to set as F3(S), since the root super-state pair [symbol] S₁, Tₘ [symbol] is reachable in D₃ and it overlay covers all other super-states.

For example, in FIG. 7B, for super-state 4= [symbol] 1, 1 [symbol] , there are three reachable super-state pairs along the deferment chains: 1= [symbol] 0, 1 [symbol] , 3= [symbol] 1, 0 [symbol] , and 0= [symbol] 0, 0 [symbol] . However, super-states 1= [symbol] 0, 1 [symbol] and 3= [symbol] 1, 0 [symbol] , do not overlay cover super-state 4= [symbol] 1, 1 [symbol] , leaving the super-state 0= [symbol] 0, 0 [symbol] as the only candidate pair, which is chosen as the deferred super-state.

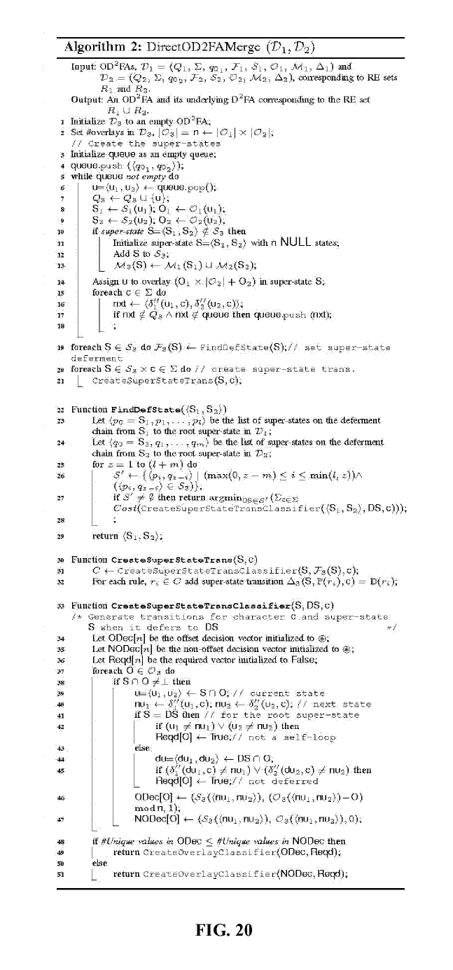

How the super-state transitions are created for the merged OD²FA is further discussed below. An exemplary embodiment of a pseudo-code representation of a DirectOD2FAMerge algorithm is shown as Algorithm 2 in FIG. 20.

In an embodiment, in the end the same optimization of merging sibling super-states together is applied for the DirectOD2FAMerge algorithm as in the case of our OD2FAMerge algorithm.

### III. Building Super State Transitions

In this section, we describe embodiments of how combine state transitions are combined into super-state transitions after the super-states have been created. The super-state transitions may be created for one super-state S and input character σ at a time. In the rest of this section, we use T to denote the current (or potential) deferred super-state of S.

### A. Ternary Representation for Overlay Sets

In an ideal scenario, one super-state transition would be created for all overlays in super-state S that have the same decision on σ. That is, the same next super-state, overlay value and offset bit. However, this would require representing an arbitrary set of overlays, which may require size that is linear in the size of the overlay set, O. In the worst case example, the combined memory requirement could approach that of a DFA.

Therefore, in an embodiment, only super-state transitions are created for overlay sets that can be concisely represented as a ternary value. More precisely, the set of overlays in any super-state transition is the ternary expansion of a ternary string. Recall that we treat the overlays as integers in the range (0, |O|] and |O| is a power of 2. In many cases, all state transitions may be combined with the same decision into a single super-state transition even with this ternary representation constraint.

### B. State Transition and Deferment Information

In an embodiment, for each overlay OεO, there may be one of the following three cases: (a) S∩O=⊥, which means the overlay is empty, (b) S∩O=s and δ″(s, σ)≠δ″(T∩O, σ), which means the state transition is not deferred, and (c) S∩O=s and δ″(s, σ)=δ″(T∩O, σ), which means the state transition is deferred. O_{f}⊂O denotes the set of filled overlays, and Oᵣ⊂O_{f} denotes the set of overlays for which the state transition is not deferred. Note that O_{f} depends on S and Oᵣ depends on S, T and σ. The super-state transitions generated for super-state S should cover all the overlays in Oᵣ.

In an embodiment, the state transition and deferment information for each overlay may be represented using a Decision array, which records the decision for each overlay, and a corresponding Boolean Required array, which records whether the transition is necessary and cannot be deferred. For empty overlays, the Decision value may be set to a special wildcard that matches any other decision and Required is set to false.

In various embodiments, for filled overlays, the Decision and Required values may be computed in different ways depending on how the OD²FA is constructed. For example, when constructing an OD²FA construction from a single RegEx or during OD2FAMerge, the underlying D²FA may be utilized to fill the Decision and Required values. In an embodiment, the D²FA lookup from the underlying D²FA corresponds to lines 33 and 34 in Algorithm 1 for the OD2FAMerge algorithm.

To provide another example, during execution of the DirectOD2FAMerge algorithm, a lookup may be performed from the input OD²FAs to fill Decision and Required values. In an embodiment, the lookup from the two input OD²FAs corresponds to lines 40 and 45 in Algorithm 2 for the DirectOD2FAMerge algorithm, as shown in FIG. 20.

In an embodiment, for the root super-state, the Required value may be set to false for self-loop state transitions, even though these transitions are not deferred. As a result, the root super-state may not store the self-looping super-state transitions. Further in accordance with such an embodiment, if a lookup fails for the root super-state, the missing transition may be determined to be a self-loop on the root super-state, so the destination super-state is the root super-state and the destination overlay is the current overlay. Since most transitions for the root super-state are self-loops, this greatly reduces the resulting number of root super-state transitions.

In an embodiment, a determination may be made regarding which of the two forms of super-state transitions (offset transitions or non-offset transitions) to create. Further in accordance with such an embodiment, a choice may be made regarding the form which results in fewer super-state transitions. To determine this, a suitable algorithm may create a Decision array for both offset and non-offset decisions and use the one which has fewer unique values in it to create the super-state transitions. In most of the cases, using the offset decision results in fewer super-state transitions.

In an embodiment, transitions for all states may be computed and stored in one super-state S and input character a at a time. Once the super-state transitions for S and σ and have been constructed, the state transitions for all the states sεS on σ may be discarded.

For example, consider super-state 1 and input character d in the OD²FA as shown in FIG. 7C. The OD²FA has four overlays, so O={0, 1, 2, 3}. In this case, O_{f}={0, 1, 2} and Oᵣ={0, 2}. Using the previous example, the offset Decision array would be [(0, 1, 1), (0, 0, 1), (0, 1, 1), Θ] and the Required array will be [true, false, true, false].

C. Overlay Classifiers

The set of state transitions for each overlay for super-state S and input character σ essentially forms a 1-dimensional classifier over the overlay field. More formally, a 1-dimensional classifier is defined over a field F and consists of a list of rules.

In an embodiment, each rule r has a predicate P(r)⊂F and a decision D(r). A packet pεF matches rule r if ρεP(r). The decision of the classifier C for a packet p is given by the first rule in C that matches p. In this context, the field F is the overlay field. The problem of creating a minimum set of covering super-state transitions then boils down to finding an equivalent ternary minimized classifier. In an embodiment, for the purpose of using a classifier to build super-state transitions over the overlay field, a special classifier that called an overlay classifier is defined.

Definition 3 (Overlay classifier): An overlay classifier C is 1-dimensional classifier over the field O. Each rule r has a Boolean flag R(r) that indicates whether rule r is required. Rules with decision S have their flag R(r) set to false. The rules in C satisfy the following properties:

Ternary predicate: For each rule rεC, its predicate P(r) is a ternary value.

Non-conflicting property: For every packet pε [symbol] _{f}, all the rules that match p (if any) also have matching decisions that are not Θ.

Covering property: For every packet pε [symbol] ᵣ, there is at least one rule rεC that matches p and R(r) is true.

In an embodiment, two overlay classifiers are deemed equivalent if for every packet in [symbol] _{f} for which both overlay classifiers have a match, they both have the same decision. Note that the two overlay classifiers by the covering property have a match for every packet in [symbol] ᵣ but not for every packet in [symbol] _{f}- [symbol] ᵣ.

### D. Constructing Initial Overlay Classifier

Given the Decision and Required values for each overlay, embodiments include first constructing an overlay classifier with one rule for each overlay. Specifically, an empty overlay classifier C may be constructed to cover O. Then, for each overlay O, the rule Rule(O, Decision[0], Required[O]) may be added to C. Here Rule(x, y, z) refers to creating a rule r with P(r)=x, D(r)=y and R(r)=z. The rules may then b minimized in C to obtain an equivalent overlay classifier C′ (which is discussed in the next section). After minimizing, each rule rεC with R(r)=true provides a combined super-state transition Δ(S, P(r), σ)=D(r) in the OD²FA.

The covering property of overlay classifiers ensures that super-state S will have a super-state transition covering every overlay in ιᵣ. The non-conflicting property of overlay classifier ensures that each overlay in [symbol] _{f} has at most one decision. Note that we can have more than one super-state transition covering an overlay, but in that case the non-conflicting property ensures that they all have the same decision.

For example, with super-state 1 and input character d in the OD²FA as shown in FIG. 7C, the overlay classifier created will have just one required rule *0→(0, 1, 1), which gives us the super-state transition

$$( 1 , * 0 ) {\to }^{d} ( 0 , 1 , 1 ) .$$

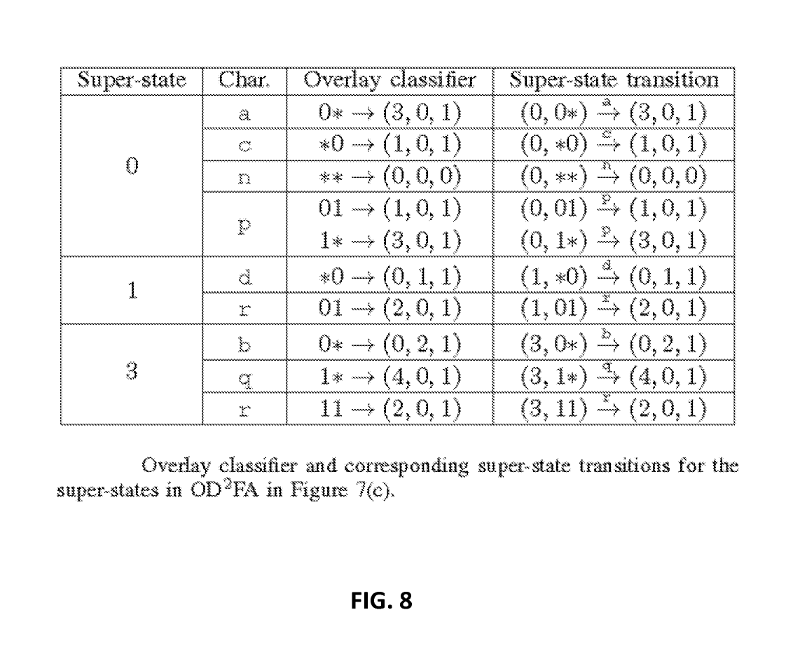

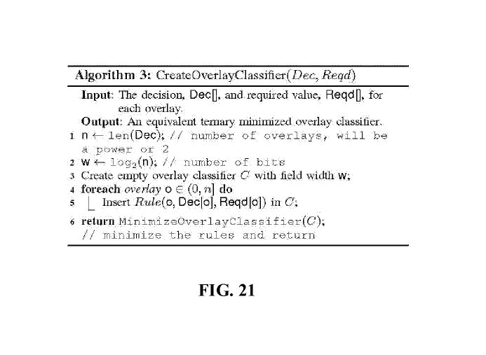

FIG. 8 is an example table showing overlay classifiers and their corresponding super-state transitions for the super-states in the OD²FA construction shown in FIG. 7C. That is, FIG. 8 shows the overlay classifiers and corresponding super-state transitions generated for all the super-states in the OD²FA in FIG. 7C. An exemplary embodiment of a pseudo-code representation for an algorithm to construct overlay classifiers is shown as Algorithm 3 in FIG. 21.

### E. Minimizing Overlay Classifier

How the initial overlay classifier created from the Decision and Required arrays is minimized is explained in this section. In an embodiment, the following two observations facilitate the combination of state transitions into fewer super-state transitions:

In an embodiment, a lookup on the OD²FA for any overlay OεO\Of for super-state S may not be required. Because of this, empty overlays may have any decision and thus can be ‘merged’ with any overlay. For example, for four overlays where overlay 2=(10)₂ is empty and overlays 0=(00)₂, 1=(01)₂ and 3=(11)₂, all have the same decision. If just the filled overlays are combined, the result is two super-state transitions with overlay sets 0* and 11. However, because it is not required to do a lookup on the empty overlay, the empty overlay may be included in the super-state transition, which results in only one super-state transition with overlay set **. In an embodiment, every empty overlay may be assigned a special wildcard decision Θ that matches any actual decision, and empty overlays mat be set as not required. Note that Condition (C2) is sufficient to ensure that transition deferment works correctly when empty overlays are included in super-state transitions.

In an embodiment, it is not necessary to defer transitions that match the deferred state. When combining state transitions, including transitions that can be deferred can result in fewer super-state transitions. For example, for four overlays where all four overlays are filled and all have the same decision but the transition for overlay 2=(10)₂is deferred, whereas the transitions for overlays 0=(00)₂, 1=(01)₂ and 3=(11)₂ are not deferred. If it is required that the transition for overlay 2 to be deferred, then two super-state transitions are needed with overlay sets 0* and 11 to cover the remaining overlays. Including the state transition for overlay 2 in the combined super-state transition results in only one super-state transition with overlay set **.

Therefore, embodiments include generalizing a bit merging algorithm to handle wildcard decision S and optional deferment. The following terminology is provided as follows. For a ternary value T, the ternary position mask of T, denoted by τ(T), may represent the binary value obtained by replacing all binary bits in T by 0 and all ternary bits (*) in T by 1. The ternary position mask of T specifies the positions in T that have a ternary bit. The binary bit mask of T, denoted by β(T), may represent the binary value obtained by replacing all ternary bits in T by 1. The ternary position mask and binary bit mask together represent a ternary value using two binary values. If bit location b is a 1 bit in τ(T), then T has a * in location b; otherwise T has the same binary bit in location b as in β(T). Thus, a ternary value T may be represented as the pair of binary values (τ(T) (β(T)).

In an embodiment, two ternary values, T₁ and T₂, are said to be ternary adjacent if τ(T₁)=τ(T₂) and τ(T₁) and τ(T₂) differ in exactly one bit. In other words, T1 and T2 are ternary adjacent if they differ in exactly one location which has a binary bit in both T₁ and T₂. The ternary cover of T₁ and T₂ is the ternary value (τ(T₁)|(β(T₁)̂β(T₂)), β(T₁)|(β(T₁)̂β(T₂))) (here 1 is bitwise OR, and ̂ is bitwise XOR). That is, the ternary cover is the ternary value obtained by replacing the differing binary bit location in T₁ (or in T₂) by the ternary bit *. Two rules are said to be ternary adjacent if their predicates are ternary adjacent and their decisions match.

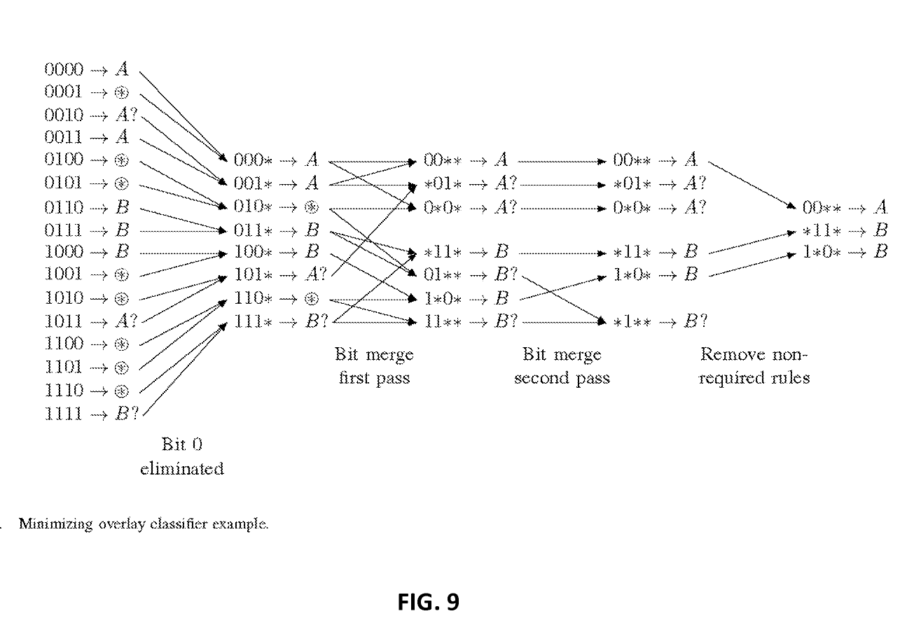

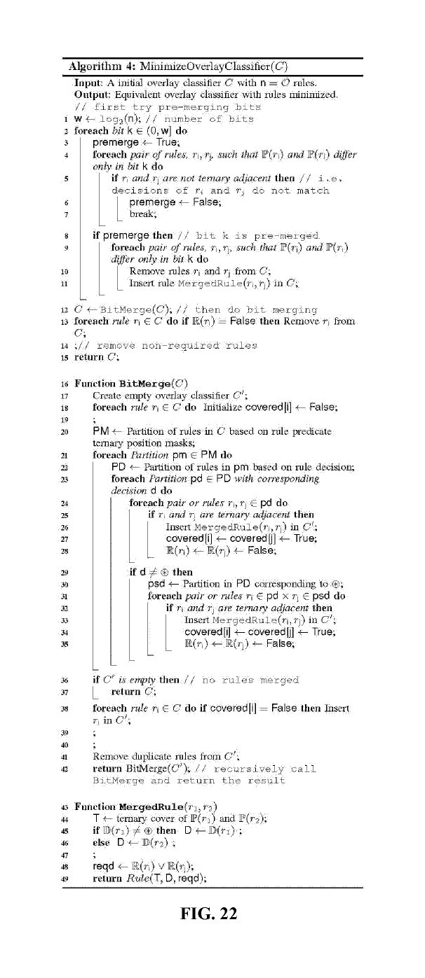

In an embodiment, the rules in the overlay classifier may be first minimized and then rules that are not required (i.e. have the R(r) flag set to false) may be removed. FIG. 9 is an example bit merging technique to minimize the overlay classifier example shown in FIG. 8 in accordance with an exemplary embodiment of the present disclosure. Minimizing the overlay classifier may be done in two steps: pre-merging bits and bit merging, which are explained using the example in FIG. 9. In accordance with an embodiment, pseudo-code for an algorithm to minimize the overlay classifier is shown as Algorithm 4 in FIG. 22.

1) Pre-merging Bits: In an embodiment, the initial overlay classifier created from the Decision and Required arrays will have |O| rules, one rule for each overlay, and the predicate of any rule rᵢ is i (the corresponding overlay value). For our example, the first column in FIG. 9 shows the initial overlay classifier. This overlay classifier has 16 overlays and two unique actual decisions A and B. A ‘?’ next to an actual decision indicates that the rule is not required (rules with a Θ decision are not required).

In an embodiment, a bit merging algorithm may be directly applied. However, in most cases, almost all overlays have the same decision. Thus, in the minimized rules, most bits will be merged to *'s. Further in accordance with such an embodiment, the speed in which the bit merging step is executed may be increased by identifying these bits and pre-merging them (e.g., with a separate algorithm) so that the bit-merging algorithm only needs to work on the few remaining bits that are not pre-merged.

In an embodiment, the pre-merging may function as follows. For a binary value ρ, \hat{0}_{b} (ρ) denotes the value obtained by inserting a 0 bit at location b, and \hat{1}_{b} (ρ) denotes the value obtained by inserting a 1 bit at location b. Bit location b is pre-merged if the following condition is true: ∀ρε[0 . . . |O|/2), D (r_{\hat{0}}_{_{b}}_{(ρ)}) matches D (r_{\hat{1}}_{_{b}}_{(ρ)}). That is, for every pair of rules whose predicates differ only in bit location b, their decisions match. Since the decisions for every such pair of rules match, these pair of rules may be merged. In an embodiment, a pair of such rules rᵢ and rⱼ may be merged into a new rule rₖ as follows. P(rₖ) is set to the ternary cover of P(rᵢ) and P(rᵢ). If D(rᵢ)≠Θ, then we set D(rₖ)←(rⱼ); otherwise we set D(rₖ)←D(rj). We set R(rₖ)←R(ri) [symbol] R(rj). Rules rᵢ and rᵢ are replaced with the merged rule rₖ.

In an embodiment, the pre-merging may function by testing and pre-merging one bit location at a time. Every time a bit is pre-merged, the number of rules is reduced by half. In the example shown in FIG. 9, bit location 0 is pre-merged, and the resulting rules are shown in the second column.

2) Bit Merging Algorithm: In an embodiment, the bit merging algorithm may run in several iterations. The input to each iteration is an overlay classifier C, and the output is an equivalent overlay classifier C′. In accordance with such an embodiment, each iteration works as follows.

First, the bit merging algorithm functions to initialize a Covered flag to false for each rule in C. For rule ri, Covered[ri] indicates if rule ri is covered by some rule in C′. Then, for every pair of rules ri and rj in C that are ternary adjacent, the merged rule rₖ may be inserted in C′. In an embodiment, the merged rule rₖ may be created in the same manner as during the pre-merging step. After inserting merged rule rₖ to C′, Covered[ri] and Covered[rj] may be set to true, and R(ri) and R(rj) may be set to false. The required flags for ri (and rj) are set to false because a rule has already been added to C′ that covers ri, and therefore any further rules to be added to C′ should not be set as required because of ri.

In an embodiment, the speed of the execution of the bit merging step may be increased by partitioning the rules based on the ternary position mask of each rule's predicate and each rule's decision. This reduces the number of pairs of rules that need to be checked for merging. In an embodiment, after all pairs have been checked for merging, any rules left in C with their Covered flag false are added to C′. The bit merging iterations may continue as long as there is at least one merged rule added to C′. When no pair of rules is merged, the process may stop and return the current overlay classifier.

For our example in FIG. 9, there are two iterations of bit merging. After the first iteration, the rules in column 3 are provided. The first rule in column 3 is obtained by merging the first two rules in column 2. After merging the first two rules in column 2, both rules will be marked non-required. Therefore, when the third rule in column 3 is created by merging the first and third rule in column 2, it may be marked as non-required. The rules in column 4 are obtained after the second iteration. No more rules can be merged after that, so the bit merging stops. Finally, the non-required rules may be removed to obtain the final overlay classifier as shown in column 5.

### F. Overlay Discussion

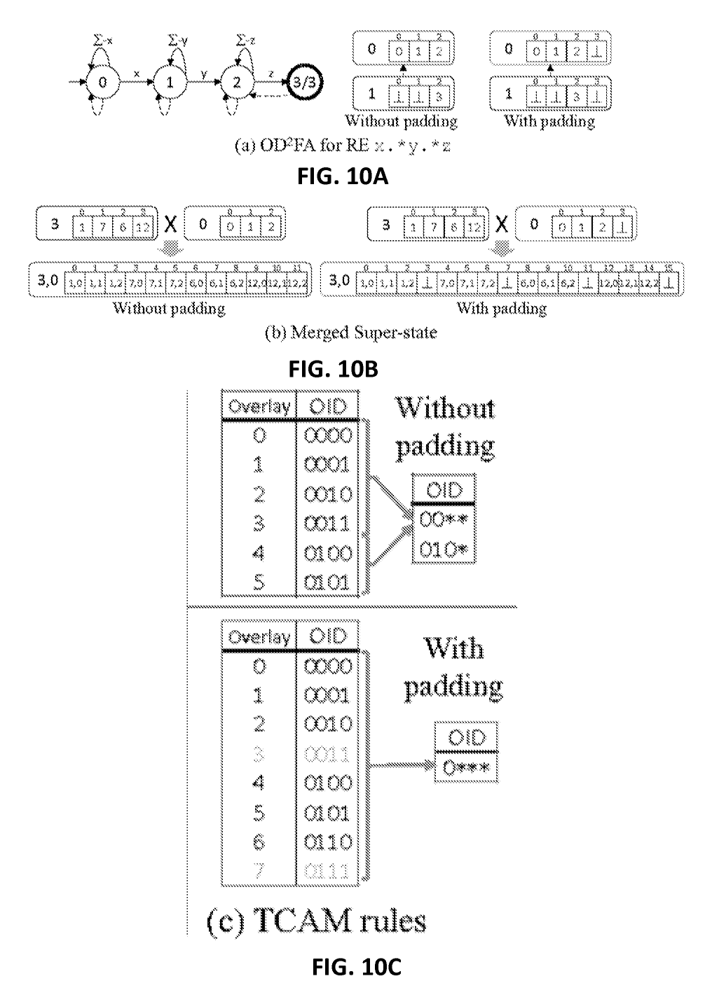

1) Restricting Overlay Count to Power of 2: In an embodiment, the number of overlays in intermediate OD²FAs and the final OD²FA that are a power of 2 may be maintained. The overlays may be numbered starting with 0 and ending with |O|−1. In an embodiment, this may be achieved by modifying the algorithm that constructs an OD²FA one RegEx (e.g., the OD²FA construction algorithm as previously discussed) from to pad empty overlays at the end, if necessary. In an embodiment, the OD²FAMerge algorithm may not require modification, since the number of overlays in the merged OD²FA is equal to the product of the number of overlays in the two given OD²FAs. The benefit of requiring the number of overlays to be a power of 2 is further explained below using the example provided in FIG. 10A.

FIG. 10A is an example block diagram of the D²FA for the RegEx /x.*y.*z/ and two possible overlay structures for the OD²FA in accordance with an exemplary embodiment of the present disclosure. In an embodiment, since there are three self-looping states in the D²FA, 0, 1 and 2, the algorithm (e.g., the modified the OD²FA construction algorithm, the OD²FAMerge algorithm, etc.) may place them in the root super-state. As shown in FIG. 10A, the overlay structure on the left has three overlays, with the three self-looping states in them, with no padding. In the right overlay structure, one empty overlay is padded so that the number of overlays is a power of 2. To provide an example, consider when this new OD²FA in FIG. 10A (with and without padding) is merged with the OD²FA in FIG. 7C, the merging of super-state 3 in FIG. 7(c), which we call S₃, and super-state 0 for the new OD²FA, which we call S₀.

FIG. 10B is an example block diagram showing the resulting super-state of the merged OD²FA shown in FIG. 10A with and without padding, in accordance with an exemplary embodiment of the present disclosure. For both cases, FIG. 10B shows the resulting super-state in the merged OD²FA, which we call Sₘ. In both cases, there will be 12 states in the merged super-state. The first three of these states are replications of state 1 in S₃, the next three states are replications of state 7 in S₃, and so on. Furthermore, states 1 and 7 in S₃ were itself replications of the state 1 of the D²FA in FIG. 5.

Hence, the first six states in Sₘ are replications of the same state (i.e. state 1) of the D²FA in FIG. 5. For the case without padding, Sₘ has 12 overlays with one state in each overlay. For the case with padding, Sₘ has 16 overlays with empty overlays 3, 7, 11 and 15. Now, since the first six states in Sₘ are replications of state 1 of the D²FA in FIG. 5, in the merged OD2FA, they will have one non-deferred transition on input character a. In both cases, the overlay offsets will be the same for all six state transitions, so all six overlays will have the same decision and will bit-merge in the overlay classifier.

FIG. 10C is an example block diagram of ternary content addressable memory (TCAM) predicate rule implementation for padded and unpadded minimized overlay classifiers in accordance with an exemplary embodiment of the present disclosure. FIG. 10C shows the (predicates of the) rules in the minimized overlay classifier for both cases. For the case without padding, six rules reduces to two rules. In the case with padding, because empty overlays 3=0011 and 7=0111 have decision during bit-merging, we can merge all six rules into a single rule.

2) Eliminating Overlay Bits: In an embodiment, the OD²FAMerge algorithm may be modified to eliminate unnecessary overlay ID bits, and thus reduce the required TCAM entry width. Performing a cross product of overlays while merging may facilitate the capture of the replication of states. Replicated states get assigned to different overlays in the same super-state. However, sometimes there is no replication and the creation of extra overlays is not necessary. For example, consider the merging of the OD²FA for RegExes /ab.*cd/ and /ab.*ef/. The two input OD²FA will both have two overlays 0 and 1, so in the merged OD²FA four overlays 0, 1, 2, and 3 are created. In this case, since both RegExes have a common prefix, there is no state replication and overlays 1 and 2 will be empty in the merged OD²FA. The two filled overlays, 0 and 3, have overlay IDs 00 and 11. Since the two overlays differ in both the bits, either bit is redundant and can be removed from the overlay ID producing only two overlays 0 and 1. In general, after merging two OD²FAs, embodiments include eliminating as many overlay ID bits as possible. For example, overlay ID bit i may be eliminated if in every pair of overlays whose overlay ID differs only in bit i, at least one of the two overlays is empty. If bit i is eliminated, one empty overlay from each pair that differ in bit i is removed. Note that the overlay count stays a power of 2.

### IV. OD²FA Software Implementation

This section discusses the implementation of OD²FA in software on a general purpose processor. The implementation of DFA and D²FA in first presented software, followed by an exemplary embodiment of an implementation of OD²FA.

Implementation of any finite automata mainly involves choosing a data structure to store the transition function and then implementing the lookup function using the given data structure. In a DFA (Q, Σ, q₀, M, δ), each state in Q has |Σ| transitions. In an embodiment, the transition function δ may be stored in memory as a 2-dimensional array of next state values, indexed over Q and Σ. Looking up the next state requires just one memory lookup in the array using the current state and input character as indices. For example, if a 4 byte state ID value is assumed, then the amount of memory required to implement the transition function would be equal to |Q|×|Σ|×4 bytes.

For a D²FA (Q, Σ, q₀, M, ρ, F), each state in Q has 0 to |Σ| transition plus the deferment pointer. Most states have only a couple of transitions. Therefore, embodiment include the transitions for each state being stored as a list of (current character, next state) pairs in memory. To do a lookup, the list of transitions may be examined for the current state to check if there is a transition on the current input character or not. If there is one, we get the next state, otherwise we go to the deferred state of the current state and check its transition table. The amount of memory required to implement the transition function is # transitions in ρ×5 bytes for the transitions and |Q|×4 bytes for the deferment pointers.

### A. Implementing OD²FA

The implementation for an OD²FA (Q, Σ, q0, F, S, O, M, Δ) is further discussed in this section. In various embodiments, each of the fields of an OD²FA may be implement. To implement Δ, a structure similar to that of a D²FA may be utilized with the exception that instead of storing next state values, pointers to overlay classifiers are stored instead. Specifically, for each super-state, a list of (current character, pointer to overlay classifier) pairs in memory may be stored for each character that is not defined. Note that a character may be deferred for some overlays, but it is not deferred if there is at least one overlay where it is not deferred.

In an embodiment, given the example current super-state S, current overlay O and current character σ, the lookup may be performed as follows. The transition list may be examined for the super-state S to determine whether there is an entry for character σ. If there is no entry for σ, the lookup may be performed using the deferred super-state for S F(S). If there is an entry for σ, this provides the location of the overlay classifier to use. A lookup may be executed for this overlay classifier for overlay O, which is further discussed below. If a match is identified, the decision provides the next super-state and overlay values. If a match is not found, then overlay O is deferred for character σ, so the lookup may be performed using the deferred super-state for S F(S).

### B. Overlay Classifier Storage and Lookup

In an embodiment, an overlay classifier is a set of one or more rules. Further in accordance with such an embodiment, each rule may have a rule predicate, which is a ternary value, and a rule decision, which is a triple of next super-state, overlay value and the offset bit. For example, if a 4 byte overlay of id values is utilized, then the rule predicate may be stored using two 4 byte values. One value may correspond to the ternary position mask of the rule predicate, and the other value may correspond to the binary bit mask of the rule predicate. To provide another example, the rule decision may also be stored as two 4 byte values, one for the next super-state and the other for the overlay value. The single offset bit may be encoded in either of these two values. In an embodiment, the list of rules is stored in memory and uses 16 bytes per rule.

In an embodiment, the lookup for an overlay O may be performed as follows. The list of rules is read and a check may be performed to determine whether any rule matches the overlay O. This check may be performed, for example, by checking whether the rule predicate P(r) covers O. P(r) is said to cover O if all the bit locations that contain a binary bit in P(r) have the same bit in both P(r) and O. This check may be performed using just one bitwise OR by testing (O|τ(P(r)))=β(P(r)), which results in an efficient implementation.

### C. Space Requirement

In an embodiment, for the OD²FA, |S|×4 bytes may be utilized to store the super-state deferment pointers, and approximately |S| bytes to store the super-state match function M. If m=Σ_{SεS} (# of non-deferred characters for S), then m×5 bytes may be utilized to store the overlay classifier pointers. In an embodiment, the size required to store the overlay classifiers may be optimized by exploiting the following observation. The same overlay classifier may be used by multiple super-states for multiple characters. Rather than storing the same overlay classifier multiple times, embodiments include storing one copy of each unique overlay classifier. In each super-state transition list, the same pointer may be used by each entry that points to the same overlay classifier. The memory required to store the overlay classifiers will be 16 times the total number of rules among all the unique overlay classifier stores.

### V. OD²FA Implementation in TCAM

In this section, an explanation is provided regarding how OD²FA may be implemented in TCAM. An embodiment of an OverlayCAM algorithm for implementing OD²FA in a TCAM is also provided. TCAM-based implementations of automata typically use two tables to represent an automata: a TCAM lookup table with a source state ID column and an input character column, and a corresponding SRAM decision table which contains the next state ID. To implement OD²FA in TCAM, embodiments include utilizing the unique pair of super-state ID and overlay ID as source state ID in the TCAM lookup table and next state ID in the SRAM decision table.

The super-state ID and overlay ID columns in TCAM may be filled with ternary values that together match multiple states rather than a single state, whereas the super-state ID and overlay ID columns in SRAM will be binary values that together match a single state. In an embodiment, an extra bit may be added in the SRAM decision table to specify the overlay bit in the super-state transition decision. Further in accordance with such an embodiment, the first match feature of TCAMs may be leveraged to ensure that the correct transition will be found in the TCAM lookup table. For example, if super-state S defers to super-state S′, then all the super-state transitions for super-state S before those of super-state S′ may be listed. Several of the key steps in OverlayCAM are described in the remainder of this section.

### A. Generating Super-state IDs and Codes

As will be appreciated by those of ordinary skill in the relevant art(s), for super-states, any suitable shadow encoding algorithm may be applied on the super-state deferment forest of the given OD²FA to generate a binary super-state ID SSID(S) and a ternary super-state shadow code SSCD(S) for each super-state S that satisfy the following four properties: (1) Uniqueness Property: For any two distinct super-states S₁ and S₂, ID(S₁)≠ID(S₂) and SC(S₁)≠SC(S₂). (2) Self-Matching Property: For any super-state S, ID(S)εSC(S) (i.e., ID(S) matches SC(S)). (3) Deferment Property: For any two super-states S₁ and S₂, S₁-S₂ (i.e., S₂ is an ancestor of S₁ in the given deferment tree) if and only if SC(S₁)⊂SC(S₂). (4) Non-interception Property: For any two distinct super-states S₁and S₂, S₁ [symbol] S₂ if and only if ID(S₁)εSC(S₂). FIG. 7(c) shows the SSIDs and SSCDs generated for that OD2FA.

### B. Implementing Super-state Transitions

The implementation of super-state transitions in TCAM is address dint his section. For example, let

$$( {S}_{1} , X ) {\to }^{σ} ( {S}_{2} , o , b )$$

be the super-state transition that is to be implemented in TCAM. Continuing this example, in the TCAM table, SSCD(S₁) may be used in the super-state ID column. Since the set of overlays in any super-state transition may be restricted to ternary values, this allows just X to be utilized in the overlay ID column of the TCAM. Continuing this example, for the SRAM, in the super-state ID column, SSID(S₂) may be used. Further, in the overlay ID column, the binary representation of the overlay value o may be used, and the offset bit b may be stored in the offset bit location in the SRAM.

In an embodiment, the RegEx matching process works in accordance with the following explanation. Let S represent the current super-state, O represent the current overlay and σ the current input character. So s=SSID(S) O denotes the current state; s concatenated with σ is used as a TCAM lookup key. Further, let uid represent the SSID stored in super-state ID column in SRAM and o represent the value stored in the overlay ID column in SRAM and b represent the value of the offset bit stored in SRAM. In accordance with an embodiment, the next super-state ID and overlay ID may be computed in the following manner.

The next super-state ID will be uid. The next overlay ID will be (b×O(s)+o) mod |O|. If b=0, the next overlay ID is simply o. If b=1, the next overlay ID is (O(s)+o) mod |O|; in most cases where o=0, the next overlay ID is (O(s)+0) mod |O|=O(s). For example, consider the OD²FA in FIG. 7C. Using this example, the super-state transition Δ(0₃, {0, 1}, a)=(3₃, 0, 1) is represented as follows. The TCAM super-state ID column is filled with SSCD(0₃)=***, the TCAM overlay ID column is 0*, the SRAM super-state ID column is filled with SSID(3₃)=011, the overlay ID column is filled with 0, and the offset bit is set to 1.

In an embodiment, the TCAM entries for OD²FA may be generated by generating the TCAM entries for one super-state at a time. For example, if S is the current super-state, the overlay classifiers of super-state S may be utilized to generate its TCAM rules. For each character for which S has an overlay classifier, a TCAM entry may be added for each rule in the overlay classifier as described in the previous section. After building this initial TCAM table for S, the TCAM entries may be reduced as follows.

In an embodiment, the bit merging algorithm, as previously discussed, may be applied to the TCAM entries generated for the super-state. In accordance with such an embodiment, the predicate of each rule corresponding to the TCAM entries has three parts: the current super-state code SSCD(S), the overlay set X, and the current input character. The SSCD(S) part will be the same in the TCAM rules corresponding to S. Because the bit merging algorithm was already applied on the overlay field while building the overlay classifiers, the TCAM rules cannot be merged using any bits from these two fields. However, rules may be merged based on the current input character field. Such embodiments may be particularly useful with case insensitive searches where transitions on the alphabet characters will mostly occur in pairs and such pairs can be merged because they differ on only one bit in ASCII encoding.

In an embodiment, the TCAM tables of the super-states may be ordered according to the super-state deferment relationship (every super-state table occurs before its deferred super-state table). Furthermore, the overlay classifiers for the root super-state exclude all the self-looping transitions. These transitions are handled by the last rule added in the TCAM, which is all *s.

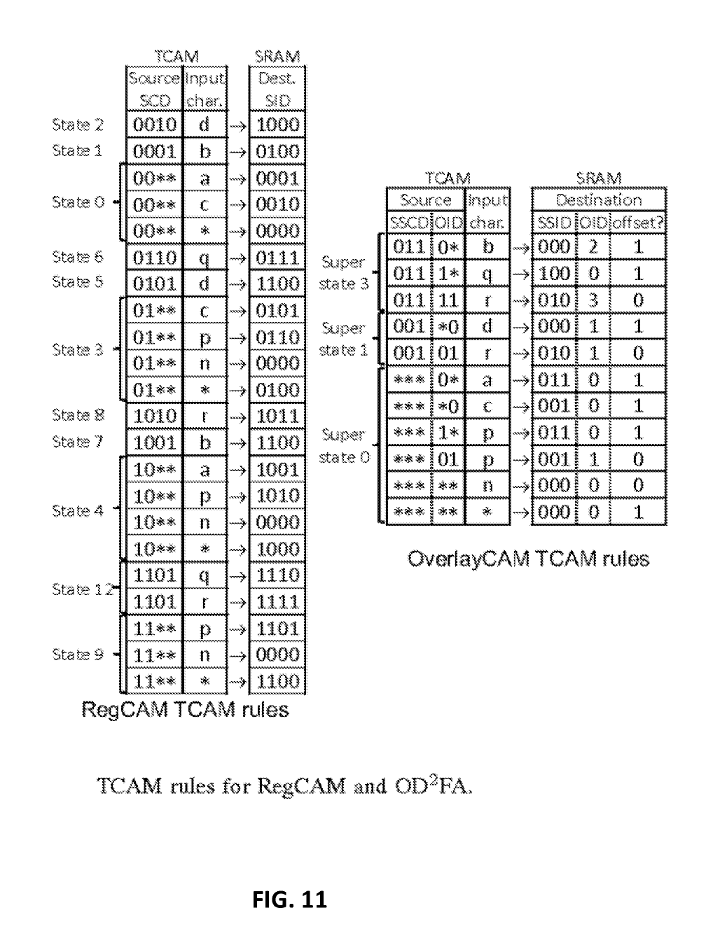

FIG. 11 is an example block diagram showing final TCAM and SRAM rule tables corresponding to the OD²FA construction shown in FIG. 7 for an identical RegCAM algorithm for the same RegEx set {/ab[̂n}*pq/ , /cd{̂n]*pr/} in accordance with an exemplary embodiment of the present disclosure.

### D. Variable Striding

In this section, how the technique of variable striding are adapted for implementation with OD²FA is explained. The basic idea of a variable striding in a DFA is explained as follows. Creating a full k-stride DFA leads to space explosion because of two reasons. First each state in a k-stride DFA has |Σ|^{k} transitions, which leads to transition explosion. Second, anytime a k-stride transition passes through an accepting state, multiple copies of the destination state may need to be generated to record the matching, which leads to state explosion.

As will be appreciated by those of ordinary skill in the relevant art(s), the k-var-stride DFA in which each transition has a variable stride between 1 and k. The transition decision stores the stride length of the transition along with the destination state. A k-var-stride DFA handles both these problems by using variable stride transitions. The problem of transition explosion is managed by selectively extending the stride of a limited number of transitions. The problem of state explosion is eliminated by not extending a transition past an accepting state.

In one embodiment, self-loop unrolling variable striding may be implemented. In other embodiments, full variable striding may be implemented. These embodiments are further discussed below.

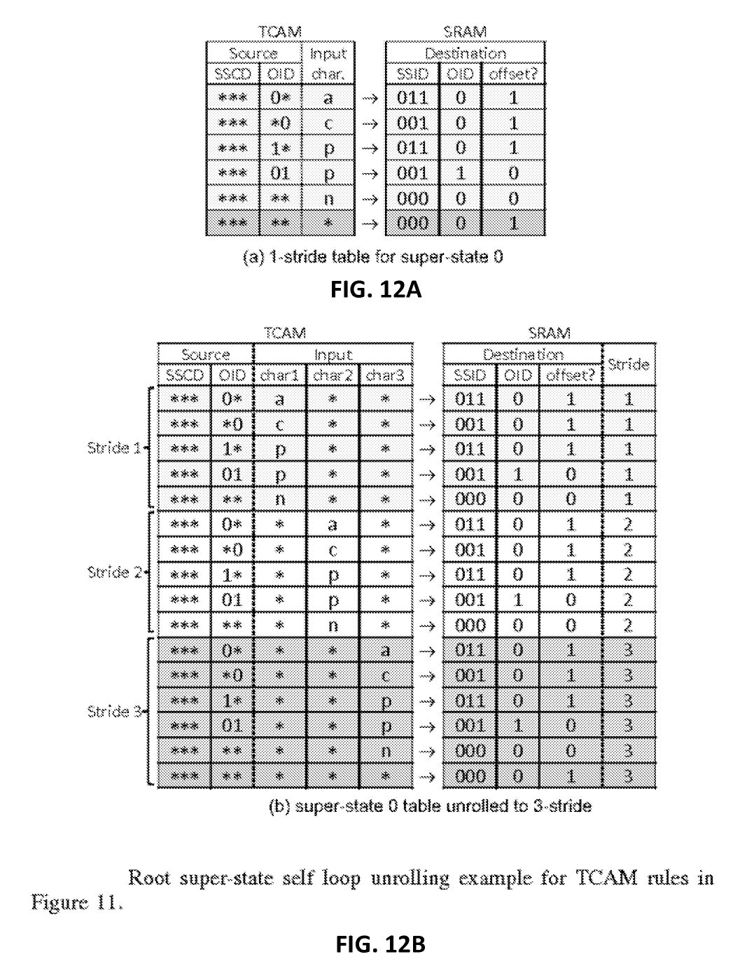

1) Self-loop Unrolling: FIG. 12A is block diagram showing a 1-stride table for an example super-state 0 self-loop unrolling example of the TCAM rules shown in FIG. 11 in accordance with an exemplary embodiment of the present disclosure. In an embodiment, the last rule in the TCAM table for the root super state is a self-loop rule, which handles all the self-looping transitions for all the states in the root super-state. For example, consider the TCAM table for the root super-state (0) in FIG. 11, which is also shown in FIG. 12A.

FIG. 12B is block diagram showing a 3-stride table for an example super-state 0 self-loop unrolling example of the TCAM rules shown in FIG. 11 in accordance with an exemplary embodiment of the present disclosure. Consider the lookup when the next two input characters are xa and 0 is the current super-state. On the first input character x, the last self-loop rule is matched, which indicates that after processing the current character we return to the same state. In accordance with an embodiment, the last self-loop rule may be replaced with another copy of super-state 0s TCAM table, with the input character over the second stride and *s in the first stride. This is shown in FIG. 12B with this second copy of the rules marked as Stride-2. If a lookup is performed for xa, the first Stride-2 rule is matched. Thus, instead of performing two lookups in the 1-stride table, the same decision may be realized by performing one lookup in the unrolled 2-stride table.

If the self-loop rule is unrolled at the end of the second copy of the TCAM rules one more time, the table shown in FIG. 12B is realized. The self-loop rule may be further unrolled to extend to a k-stride table. That is, if the 1-stride TCAM table has n rules, then the self-loop unrolled k-stride table will only have (n−1)k+1 rules.

2) Full Variable Striding: As will be appreciated by those of ordinary skill in the relevant art(s), any suitable k-var-stride transition sharing algorithm may be implemented to generate k-var-stride tables, which correctly handle state deferment in the D²FA. For example, suppose S₁ is the current state and it defers to state S₂. If a character lookup is performed and a rule is matched from state S₂'s TCAM table giving the next state S₃, then state S₁ also transitions to state S₃ on the same input. In general, a match may be found in the TCAM table of an ancestor of S₁ when performing a lookup for S₁ will be correct.

The k-var-stride transition sharing algorithm may not be extended to OD²FA to generate tables that correctly handle deferment because, in an OD²FA, each super-state has multiple states. On the same input, different states in the same super-state might transition to states in different super-states. Thus, various embodiments include an alternate technique to generate variable stride tables.

In an embodiment, for each super-state S, a k-var-stride table may be generated in addition to its 1-stride table. When the k-var-stride table is implemented in TCAM, in the current super-state column of the TCAM, SSID(S) may be utilized instead of the SSCD(S). In this way, the k-var-stride rules of super-state S will only match when doing a lookup for itself and will not match when doing a lookup for any other super-state. Therefore, the k-var-stride rules only have to be correct for S. The k-var-stride table for S may be placed just before its 1-stride table in TCAM, so higher priority is given to k-var-stride rules over the 1-stride rules.

In an embodiment, an algorithm may be implemented to generate the k-var-stride table for a super-state. For example, the variable stride transition function may be defined as Γ: S×2^{o}×(U_{1≦i≦k}τi)→S×[0 . . . |O|)×{0, 1}, which is same as Δ except that Γ transitions over a string of characters of length between 1 and k. Further, let S be the super-state for which the k-var-stride transitions are generated. In an embodiment, for each 1-stride transition for super-state S, k-var-stride transitions are built by extending the transitions of super-state S₂ with that transition in two ways: first by composing with S₂'s k-var-stride table, and then by composing with S₂'s 1-stride table. More specifically, let

$$( S , X ) {\to }^{σ} ( {S}_{1} , {o}_{1} , 1 )$$

εΔ be any 1-stride transition for S, such that S<S₁ and M(S₁)=. In an embodiment, the condition S<S₁ is added to only extend forward transitions, and this condition is true for most forward transitions. Furthermore, the condition M(S₁)= is added to stop a variable stride transition at matching super-states.

In an embodiment, if the k-var-stride transition table for super-state S₁ has not yet been built, it is first built recursively. Then, the transitions in the k-var-stride table of S₁: for each transition

$$( {S}_{1} , Y ) {\to }^{w} ( {S}_{2} , {o}_{2} , 1 )$$

are first extended in the k-var-stride transition table of S₁, if |X∩Y| is large enough and len(w)<k, the extended transition

$$( S , X ⋂ Y ) {\to }^{σ , w} ( {S}_{2} , {o}_{1} + {o}_{2} , 1 )$$

mod |O|, 1) may be added to the k-var-stride transition table for S.

Next, the transitions in the 1-stride table of S₁: for each transition

$$( {S}_{1} , Y ) {\to }^{{σ}_{2}} ( {S}_{2} , {o}_{2} , 1 )$$

is extended in the 1-stride transition table of S₁, if |X∩Y| is large enough, extended transition

$$( S , X ⋂ Y ) {\to }^{σ , {σ}_{2}} ( {S}_{2} , {o}_{1} + {o}_{2} , 1 )$$

mod |O|, 1) is added to the k-var-stride transition table for S. In an embodiment, the condition |X∩Y|≧min(|X|,|Y|)/4 may be utilized as the measure for what constitutes a threshold of being “large enough.” When one transition is extended to the next, the extended transition can only cover overlays that are common in both initial transitions. Ideally it is preferable for both transitions to cover the exact same set of overlays (in most cases this is true). But even when the same overlay set is not obtained in such a manner, if the size of the intersection is significant compared to the number of overlays covered by the two initial transitions, it is worthwhile to add the extended transition. In accordance with an embodiment, the 1-stride transitions that are on the whitespace characters are not extended, as extending 1-stride transitions on these characters may significantly increase the number of TCAM rules while only marginally (if at all) increasing the average stride.

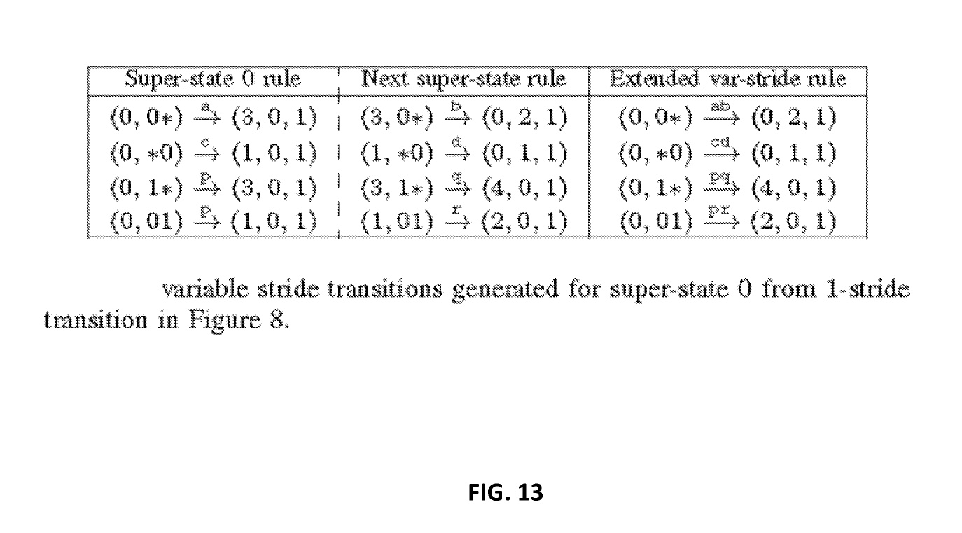

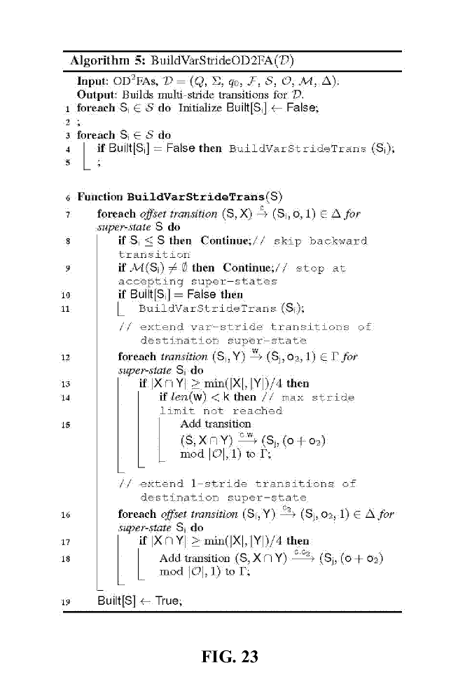

FIG. 13 is block diagram showing variable stride transitions generated for super-state 0 from 1-stride transition in FIG. 8 in accordance with an exemplary embodiment of the present disclosure. In an embodiment, pseudo-code for an exemplary algorithm to build the k-var-stride transition tables is shown as Algorithm 5 in FIG. 23.

### VI. Experimental Results

In an embodiment, implementing OverlayCAM using C++ experiments have been conducted to evaluate its effectiveness and scalability. Results have been verified by confirming that the TCAM table generated by OverlayCAM is equivalent to the original DFA. That is, for every pair of current state and input character, the next state returned by the TCAM lookup matches the next state returned by the DFA.

### A. Effectiveness of OverlayCAM

The effectiveness of an example implementation of OverlayCAM on 8 real-world RegEx sets have been evaluated. The following metric has been defined for measuring the amount of state replication in the DFA that corresponds to a RegEx set. For any RegEx set R, SR(R) is defined as the ratio of the number of states in the minimum state DFA corresponding to R divided by the number of states in the standard NFA without a transitions corresponding to R.

The 8 real-world RegEx sets included 4 RegEx sets from a large networking vendor (i.e., C7, C8, C10, and C613) and 4 RegEx sets from Bro and Snort (i.e., Bro217, Snort24, Snort31, and Snort34). For each set, the number indicated the number of RegExes in the RegEx set. Based on the characteristics of the RegExes, these eight sets were partitioned into three groups, STRING ={C613, Bro217}, which contains mostly strings, causing little state replication (SR(Bro271)=3.0, SR(C613)=2.1); WILDCARD={C7, C8 and C10}, which contains multiple wildcard closures ‘.*’, causing lots of state replication (SR(C7)=231, SR(C8)=43, and SR(C10)=162); and SNORT={Snort24, Snort31, and Snort34}, which contain a diverse set of RegExes, roughly 40% of the RegExes have wildcard closures, causing moderate state replication (SR(Snort24)=24, SR(Snort31)=22, and SR(Snort34)=16).

A side-by-side comparison was conducted with RegCAM-TC (RegCAM without Table Consolidation) and RegCAM+TC (RegCAM with Table Consolidation) on all 8 real-world RegEx sets. For RegCAM+TC, 4 tables were consolidated together. The results are shown in Table II below. For TCAM space, only the number of TCAM entries have been reported. Since TCAM width typically is only allowed to be configured as 36, 72, or 144 bits, a TCAM width of 36 was used in all cases. TCAM lookup speed is typically higher for smaller TCAM chips. For the experiment, a well-adopted TCAM model has been utilized to calculate RegEx matching throughput. For the two string-based RegEx sets Bro217 and C613, it is observed that OverlayCAM does not significantly outperform the two RegCAM algorithms, which is expected as OverlayCAM is designed to handle state replication and string-based RegEx sets have little state replication.

TABLE II
EXPERIMENTAL RESULTS OF OVERLAYCAM ON 8 REGEX SETS IN COMPARISON
WITH REGCAM − TC AND REGCAM + TC

| | # | | # | | # | # TCAM entries | | |
|---|---|---|---|---|---|---|---|---|
| RE | NFA | | NFA | # | Super | RegCAM − | RegCAM + | Overlay |
| set | States | SR | Trans. | Overlays | states | TC | TC | CAM |
| C8 | 72 | 43.17 | 2177 | 72 | 85 | 3722 | 1012 | 125 |
| C10 | 92 | 161.61 | 2982 | 288 | 133 | 17824 | 4739 | 263 |
| C7 | 107 | 231.31 | 3261 | 648 | 127 | 29196 | 8315 | 234 |
| Snort24 | 575 | 24.15 | 4054 | 30 | 897 | 16130 | 5310 | 1426 |
| Snort34 | 891 | 15.52 | 4731 | 48 | 1151 | 16297 | 5026 | 2293 |
| Snort31 | 917 | 21.88 | 5738 | 32 | 2395 | 41539 | 14464 | 9478 |
| Bro217 | 2132 | 3.06 | 5424 | 2 | 3401 | 9143 | 5087 | 6028 |
| C613 | 5343 | 2.12 | 14563 | 1 | 11308 | 18256 | 13182 | 18256 |

| | SRAM size (Kb) | | | Throughput (Gbps) | | |
|---|---|---|---|---|---|---|
| RE | RegCAM − | RegCAM + | Overlay | RegCAM − | RegCAM + | Overlay |
| set | TC | TC | CAM | TC | TC | CAM |
| C8 | 47.25 | 51.39 | 1.83 | 5.44 | 8.51 | 12.50 |
| C10 | 261.09 | 277.68 | 4.62 | 3.11 | 4.35 | 12.12 |
| C7 | 456.19 | 519.60 | 4.57 | 3.11 | 3.64 | 12.31 |
| Snort24 | 236.28 | 331.88 | 26.46 | 3.64 | 4.35 | 7.27 |
| Snort34 | 238.73 | 294.49 | 42.55 | 3.64 | 4.35 | 5.44 |
| Snort31 | 689.61 | 960.50 | 185.12 | 2.72 | 3.64 | 3.64 |
| Bro217 | 133.93 | 317.94 | 88.30 | 3.64 | 4.35 | 4.35 |
| C613 | 320.91 | 978.35 | 338.73 | 3.11 | 3.64 | 3.11 |

However, for the other RegEx sets, OverlayCAM algorithm significantly outperformed RegCAM and often outperforms NFAs. Overlay-CAM uses orders of magnitude less TCAM and SRAM than RegCAM. On average, OverlayCAM uses 41 times less TCAM and 33 times less SRAM than RegCAM-TC and 12 times less TCAM and 38 times less SRAM than RegCAM+TC. Also, OverlayCAM has significantly higher throughput than RegCAM. On average, OverlayCAM has 2.5 and 1.93 times higher throughput than RegCAM-TC and RegCAM+TC, respectively. Further, the total number of TCAM entries used by OverlayCAM is often (far) smaller than the total number of NFA transitions. For C7, OverlayCAM's number of TCAM entries is 14 times less than the number of NFA transitions.

Further still, OverlayCAM is very effective in conquering state replication. OverlayCAM effectively and automatically identifies all NFA state replicates and groups them together into super-states. The number of super-states is, on average, 1.55 times the number of NFA states and is not more than 2.61 times the number of NFA states. Because of this, the larger SR(R) is, the more that OverlayCAM outperforms RegCAM. For C7, OverlayCAM uses 125 times less TCAM and 100 times less SRAM than RegCAM-TC and 36 times less TCAM and 114 times less SRAM than RegCAM+TC. Additionally, OverlayCAM effectively multiplies the compression benefits of conquering state replication and transition sharing. That is, OverlayCAM effectively multiplies the benefits of ODFA and D²FA. The average number of TCAM entries per super-state is only 2.14, even when super-states have hundreds of constituent states.

### B. Results on 7-Var-Stride

The results of applying the variable striding technique with k=7 on OverlayCAM have been compared with the results for RegCAM-TC. The average stride values achieved and the number of resulting TCAM rules have also been compared. Since the RE sets in the STRING group have no (or limited) state replication, comparisons made only use the RegEx sets in the WILDCARD and SNORT groups.

### 1) Self-Loop Unrolling

The root state in both RegCAM-TC and OverlayCAM are exactly the same since the self-looping states are selected as the root states. As a result, the resulting TCAM rules after unrolling the roots states are semantically equivalent. Hence, the exact same average stride values are obtained for both algorithms (which are shown in Table IV further below). Table III directly below shows the number of TCAM rules required without self-loop unrolling (i.e. for 1-stride) and with self-loop unrolling for both the algorithms.

TABLE III
NUMBER OF TCAM RULES FOR REGCAM −
TC AND OVERLAYCAM FOR 1-STRIDE, WITH
SELF-LOOP UNROLLING AND WITH 7-VAR-STRIDE

| | RegCAM − TC | | | OverlayCAM | | |
|---|---|---|---|---|---|---|
| RE set | 1-stride | Unroll | var-stride | 1-stride | Unroll | var-stride |
| C8 | 3722 | 7794 | 8192 | 125 | 310 | 814 |
| C10 | 17824 | 36336 | 65536 | 263 | 590 | 1113 |
| C7 | 29196 | 64356 | 65536 | 234 | 442 | 1381 |
| Snort24 | 16130 | 18627 | 32768 | 1426 | 1482 | 6942 |
| Snort34 | 16297 | 19825 | 32768 | 2293 | 2577 | 9654 |
| Snort31 | 41539 | 43920 | 65536 | 9478 | 9819 | 32243 |

Compared to RegCAM-TC, OverlayCAM requires on average 77 times less TCAM rules for the WILDCARD group and 8 times less TCAM rules for the SNORT group. Also, the average percentage increase in the number of TCAM rules resulting from unrolling the roots for the SNORT group is 14.3% for RegCAM-TC and only 6.6% for OverlayCAM. This is because in RegCAM-TC there are many root states that are unrolled whereas in OverlayCAM there is only one root super-state that is unrolled.

### 2) Full Variable Striding:

Table III above shows the number of TCAM rules required for full variable striding, and Table IV below shows the average stride values for RegCAM-TC and Overlay-CAM. As indicated by these table, OverlayCAM requires much less TCAM rules than RegCAM-TC. On average, OverlayCAM requires 38.8 times fewer rules for the WILDCARD group and 3.4 times fewer TCAM rules for the than SNORT.

TABLE IV
AVERAGE STRIDE VALUES FOR SELF-LOOP UNROLLING AND
7-VAR-STRIDE FOR REGCAM − TC AND OVERLAYCAM FOR
p_{M} = 0, 50 AND 95.

| | Self-loop | | | 7-var-stride | | | | | |
|---|---|---|---|---|---|---|---|---|---|
| RE | unroll | | | RegCAM − TC | | | OverlayCAM | | |
| set | 0 | 50 | 95 | 0 | 50 | 95 | 0 | 50 | 95 |
| C8 | 6.1 | 2.9 | 1.8 | 6.1 | 4.1 | 2.9 | 6.1 | 3.8 | 3.7 |
| C10 | 5.9 | 3.4 | 1.9 | 6.0 | 4.5 | 3.2 | 5.9 | 4.1 | 3.6 |
| C7 | 6.1 | 1.9 | 1.8 | 6.1 | 3.7 | 3.8 | 6.1 | 2.7 | 3.8 |
| Snort24 | 5.6 | 1.7 | 1.1 | 5.7 | 2.9 | 3.6 | 5.6 | 2.4 | 4.0 |
| Snort34 | 5.9 | 1.7 | 1.1 | 5.9 | 3.4 | 3.7 | 5.9 | 2.5 | 4.1 |
| Snort31 | 6.1 | 1.7 | 1.1 | 6.2 | 2.8 | 2.3 | 6.1 | 2.3 | 2.9 |

In general, OverlayCAM is able to achieve nearly the same average stride values as RegCAM-TC. For random traffic (pM=0), OverlayCAM has nearly identical average stride value as RegCAM-TC. This is because with random traffic, most of the transitions taken are self-loops around the root state, which are unrolled to 7-stride in both algorithms. For pM=95, OverlayCAM is able to achieve equal or higher average stride value than RegCAM-TC for all the RegEx sets. This is because with pM=95, most of the transitions taken are forward transitions, and OverlayCAM is able to selectively combine longer chains of forward transitions in to higher stride transitions than RegCAM-TC. The average of the ratio of the stride values across all RegEx sets and pM values is only 1.09.

### C. Scalability of OverlayCAM

The scalability of OverlayCAM on synthetic RegEx sets constructed by adding new RegExes from 13 RegExes from a recent release of the Snort rules one at a time has been evaluated. Each RegEx contains closure on the wildcard or a range; these cause the DFA size to double as each RegEx is added. The final DFA has 225,040 states.

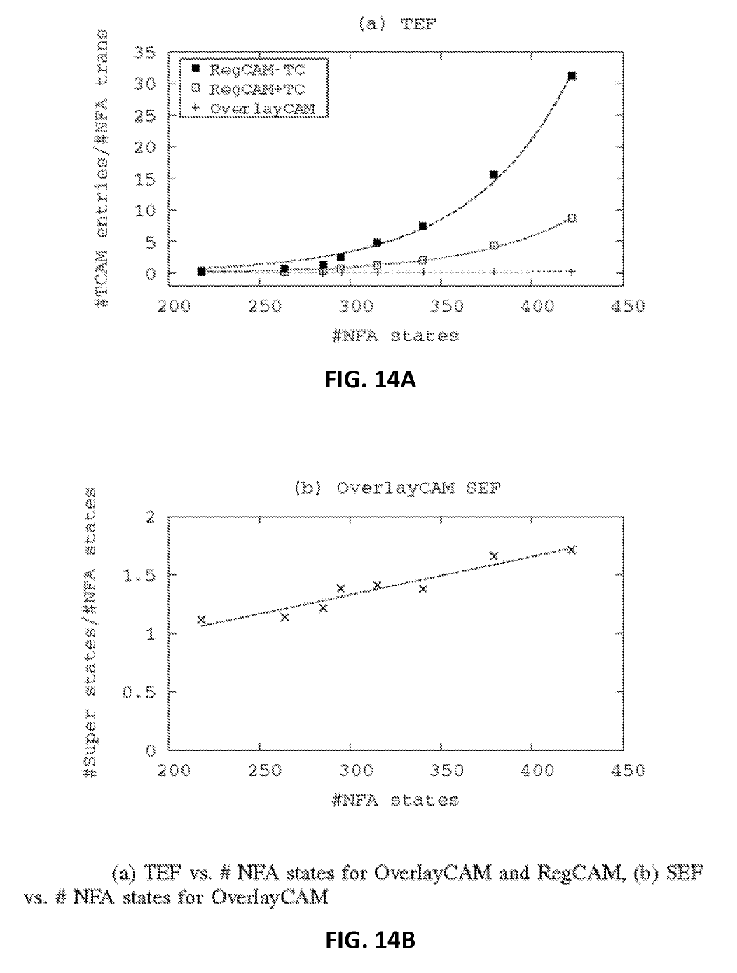

First the TCAM Expansion Factor (TEF) of a RegEx set is defined to be the number of TCAM entries divided by the number of NFA transitions. FIG. 14A is an example graph showing TCAM expansion factor (TEF) versus a non-deterministic finite (NFA) states of a RegEx set for OverlayCAM and RegCAM algorithms. In FIG. 14A, the TEF for RegCAM-TC, RegCAM+TC and OverlayCAM is plotted. The first 5 data points have been omitted because the corresponding 5 DFAs are too small. As expected, the TEF of the RegCAM algorithms grows exponentially with the number of NFA states due to state replication. In contrast, the TEF of OverlayCAM grows linearly at a very slow growth rate with the number of NFA states.

Next, the super-state expansion factor (SEF) of a RegEx set is defined as the number of super-states divided by the number of NFA states. FIG. 14B is an example graph showing super-state expansion factor (SEF) versus non-deterministic finite (NFA) states of a RegEx set for an OverlayCAM algorithm. FIG. 14B shows that the SEF of OverlayCAM also grows linearly and slowly with the number of NFA states. Note that for any RegEx set, the number of NFA states is the minimum compared to any other automaton.

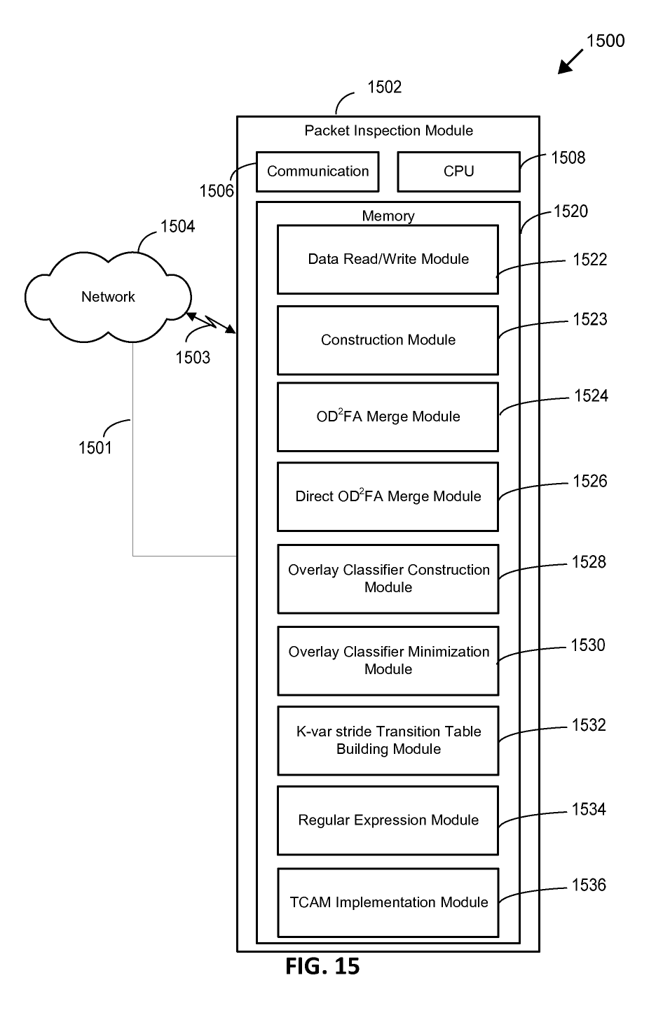

FIG. 15 is an example block diagram of a packet inspection system 1500 in accordance with an exemplary embodiment of the disclosure. Packet inspection system 1500 includes a packet inspection module 1502 configured to connect to a network 1504 via any suitable number of wired and/or wireless links 1501 and 1503, respectively. Network 1504 may include any appropriate combination of wired and/or wireless communication networks. For example, network 1504 may include any combination of a local area network (LAN), a metropolitan area network (MAN), a wide area network (WAN), and may facilitate a connection to the Internet. To provide further examples, network 1504 may include wired telephone and cable hardware, satellite, cellular phone communication networks, etc.

In an embodiment, packet inspection module 1502 may include a communication unit 1506, a central processing unit 1508, and a memory 1520. Packet inspection module 1502 may be implemented as any computing device suitable for inspecting data using one or more regular expressions. In various examples, packet inspection module 1502 may be implemented within a server, a router, a switch, a firewall, a network hub, as one or more portions of a ternary content addressable memory (TCAM) system, as one or more portions of a content addressable memory (CAM) system, etc. To provide additional examples, packet inspection module 1502 may be implemented on any suitable type of network device configured to receive and/or send packetized data, on an addressable user equipment device, as part of a desktop computer, laptop computer, mobile computing device (such as a mobile phone), etc.

In an embodiment, communication unit 1506 may be configured to enable data communications between packet inspection module 1502 and network 1504. In an embodiment, communication unit 1506 is configured to receive data having a structure that conforms to one or more communication protocols and/or standards from network 1504. For example, in an embodiment, communication unit 1506 may be configured to receive data packets, which could include one or more characters encoded in accordance with any suitable protocol and/or standard. In various embodiments, communication unit 1506 may be configured to facilitate the transfer of data received via network 1504 to CPU 1508 and/or to memory 1520. For example, data received from communication module 1506 from network 1504 may be stored in any suitable location in memory 1506 for subsequent processing by CPU 1508.

As will be appreciated by those of skill in the relevant art(s), communication unit 1506 may be implemented with any combination of suitable hardware and/or software to facilitate these functions. For example, communication unit 1506 may be implemented with any number of wired and/or wireless transceivers, network interfaces, physical layers (PHY), etc.

In various embodiments, CPU 1508 may be configured to communicate with memory 1520 to store to and read data from memory 1520. In various embodiments, CPU 1508 may be implemented as any suitable number and/or type of processors such as a general purpose processor, a host processor associated with packet inspection module 1502, an application-specific integrated circuit (ASIC), etc.

In accordance with various embodiments, memory 1520 may be a computer-readable non-transitory storage device and may include any combination of volatile (e.g., a random access memory (RAM), or a non-volatile memory (e.g., battery-backed RAM, FLASH, etc.). In various embodiments, memory 1520 may be configured to store instructions executable on CPU 1508. These instructions may include machine readable instructions that, when executed by CPU 1508, cause CPU 1508 to perform various acts.

In various embodiments, data read/write module 1522, OD²FA merge module 1524, direct OD²FA merge module 1526, overlay classifier construction module 1528, overlay classifier minimization module 1530, k-var stride transition table building module 1532, regular expression module 1534, and TCAM implementation module 1536 are portions of memory 1520 configured to store instructions executable by CPU 1508.

In various embodiments, data read/write module 1522 includes instructions that, when executed by CPU 1508, causes CPU 1508 to read data from and/or to write data to memory 1520. In various embodiments, data read/write module 1522 includes instructions that, when executed by CPU 1508, causes CPU 1508 to receive and/or process data received from network 1504 via communication unit 1506, which may include packetized data that may be subjected to deep packet inspection in accordance with one or more techniques as described herein.

In an embodiment, data read/write module 1522 enables CPU 1508 to access one or more regular expressions stored in regular expression module 1526, to execute one or more algorithms stored in OD²FA merge module 1524, direct OD²FA merge module 1526, overlay classifier construction module 1528, overlay classifier minimization module 1530, k-var stride transition table building module 1532, regular expression module 1534, and/or TCAM implementation module 1536, and/or to store one or more ODFA and/or OD²FA constructions in any suitable format (e.g., as look up tables LUTs) in accordance with any suitable previously discussed methods.

In various embodiments, construction module 1523 may store one or more algorithms that are executed by CPU 1508 to facilitate ODFA and/or OD²FA construction. For example, construction module 1523 may include executable code in any suitable language and/or format to store a representation of an ODFA for a set of RegExes R that is defined as a 7-tuple (Q, Σ, q0, S, O, M, Δ), as previously discussed. To provide another example, construction module 1523 may include executable code in any suitable language and/or format to store a representation of an ODFA Again, an algorithm for ODFA construction is not described herein for purposes of brevity, but may be generated utilizing one or more algorithms that are utilized as part of the OD²FA construction.

In an embodiment, CPU 1508 may execute instructions stored in construction module 1523 together with one or more module, such as OD²FA merge module 1524, direct OD²FA merge module 1526, overlay classifier construction module 1528, overlay classifier minimization module 1530, k-var stride transition table building module 1532, regular expression module 1534, and/or TCAM implementation module 1536, for example, to store a constructed ODFA and/or OD²FA model.

In various embodiments, OD²FA merge module 1524 may store one or more algorithms that are executed by CPU 1508 to facilitate ODFA and/or OD²FA construction. For example, in an embodiment, OD²FA merge module 1524 may store executable code in any suitable language and/or format that, when executed by CPU 1508, results in the execution of one or more steps as previously described with respect to the OD²FAMerge algorithm. In an embodiment, OD²FA merge module 1524 may store executable code that, when executed, functions in accordance with the pseudo code as shown in FIG. 19.

In various embodiments, direct OD²FA merge module 1526 may store one or more algorithms that are executed by CPU 1508 to facilitate ODFA and/or OD²FA construction. For example, in an embodiment, direct OD²FA merge module 1526 may store executable code in any suitable language and/or format that, when executed by CPU 1508, results in the execution of one or more steps as previously described with respect to the DirectOD2FAMerge algorithm. In an embodiment, direct OD²FA merge module 1526 may store executable code that, when executed, functions in accordance with the pseudo code as shown in FIG. 20.

In various embodiments, overlay classifier construction module 1528 may store one or more algorithms that are executed by CPU 1508 to facilitate ODFA and/or OD²FA construction. For example, in an embodiment, direct overlay classifier construction module 1528 may store executable code in any suitable language and/or format that, when executed by CPU 1508, results in the execution of one or more steps as previously described to construct an initial overlay classifier with one rule for each overlay. In an embodiment, overlay classifier construction module 1528 may store executable code that, when executed, functions in accordance with the pseudo code as shown in FIG. 21.

In various embodiments, overlay classifier minimization module 1530 may store one or more algorithms that are executed by CPU 1508 to facilitate ODFA and/or OD²FA construction. For example, in an embodiment, overlay classifier minimization module 1530 may store executable code in any suitable language and/or format that, when executed by CPU 1508, results in the minimize of the initial overlay classifier generated via execution of instructions store in overlay classifier construction module 1528. These instructions may specify, for example, pre-merging bits and bit merging rules. In an embodiment, overlay classifier minimization module 1530 may store executable code that, when executed, functions in accordance with the pseudo code as shown in FIG. 22.

In various embodiments, k-var stride transition table building module 1532 may store one or more algorithms that are executed by CPU 1508 to facilitate ODFA and/or OD²FA construction. For example, in an embodiment, k-var stride transition table building module 1532 may store executable code in any suitable language and/or format that, when executed by CPU 1508, results in the minimize of the initial overlay classifier generated via execution of instructions store in overlay classifier construction module 1528. These instructions may specify, for example, instructions to generate variable stride transitions for one or more super states to build the k-var-stride transition tables corresponding to an OD²FA construction. In an embodiment, k-var stride transition table building module 1532 may store executable code that, when executed, functions in accordance with the pseudo code as shown in FIG. 23.

In various embodiments, regular expression module 1534 may store one or more regular expressions to use in matching data received via network 1504. For example, regular expression module may store regular expression in any suitable format that are equivalent to the regular expressions used to facilitate ODFA and/or OD²FA construction and to match one or more data packet characters received via network 1504. To provide an illustrative example, regular expression module 1534 may include a regular expression such as /cd[̂n]*pr/, as illustrated and previously discussed with reference to FIG. 6.

In some embodiments, regular expression module 1534 may store a number of regular static regular expressions that do not change over time. These embodiments could be particularly useful, when, for example, packet inspection system 1500 is implemented to provide limited packet inspection functionality and/or memory space is sought to be conserved.

In other embodiments, the regular expressions stored in regular expression module 1534 are dynamic and changed over time and/or represent new regular expression inputs received at any suitable time. For example, regular expression module 1534 could receive any suitable number of regular expressions via network 1504 and/or via another source, such as a data communication bus, which is not shown in FIG. 15 for purposes of brevity. These embodiments could be particularly useful when, for example, packet inspection system 1500 is implemented as part of a more sophisticated packet analysis system, such that regular expressions stored in regular expression module 1534 are updated as new threats are discovered that need to be identified.

In various embodiments, TCAM implementation module 1536 may store one or more algorithms that are executed by CPU 1508 to facilitate the implementation of one or more TCAM rules. For example, TCAM implementation module 1536 may include instructions specifying how one or more TCAM entries are built based on a particular set of RegExes and an ODFA and/or OD²FA construction. For example, TCAM implementation module 1536 may facilitate the generation of one or more TCAM tables via execution of the OverlayCAM algorithm, as previously discussed.

In this way, embodiments include packet inspection module 1502 performing TCAM functions in software that would otherwise be performed using TCAM hardware. This advantageously saves cost and complexity while allowing TCAM functionality to be added to existing products via a software update as opposed to the installation of specialized hardware.

Although FIG. 15 illustrates communication unit 1506, CPU 1508, and memory 1520 as separate elements, various embodiments of packet inspection system 1500 include any portion of communication unit 1506, CPU 1508, and memory 1520 being combined, integrated, and/or separate from one another. For example, any of communication unit 1506, CPU 1508, and memory 1520 could be integrated as a single device, a system on a chip (SoC), an application specific integrated circuit (ASIC), etc.

Furthermore, although data read/write module 1522, OD²FA merge module 1524, direct OD²FA merge module 1526, overlay classifier construction module 1528, overlay classifier minimization module 1530, k-var stride transition table building module 1532, regular expression module 1534, and TCAM implementation module 1536 are illustrated as separate portions of memory 1520, various embodiments include these memory modules as being stored in any combination of any suitable portion of memory 1520, in a memory implemented as part of CPU 1508, spread across more than one memory, stored in a memory device external to packet inspection module 1502, etc.

As will be appreciated by those of ordinary skill in the relevant art(s), different memory modules may be integrated as a part of CPU 1508 to increase processing speed, to reduce latency and/or to reduce delays due to data processing bottlenecks, etc. For purposes of brevity, only a single memory 1520 is illustrated in FIG. 15.

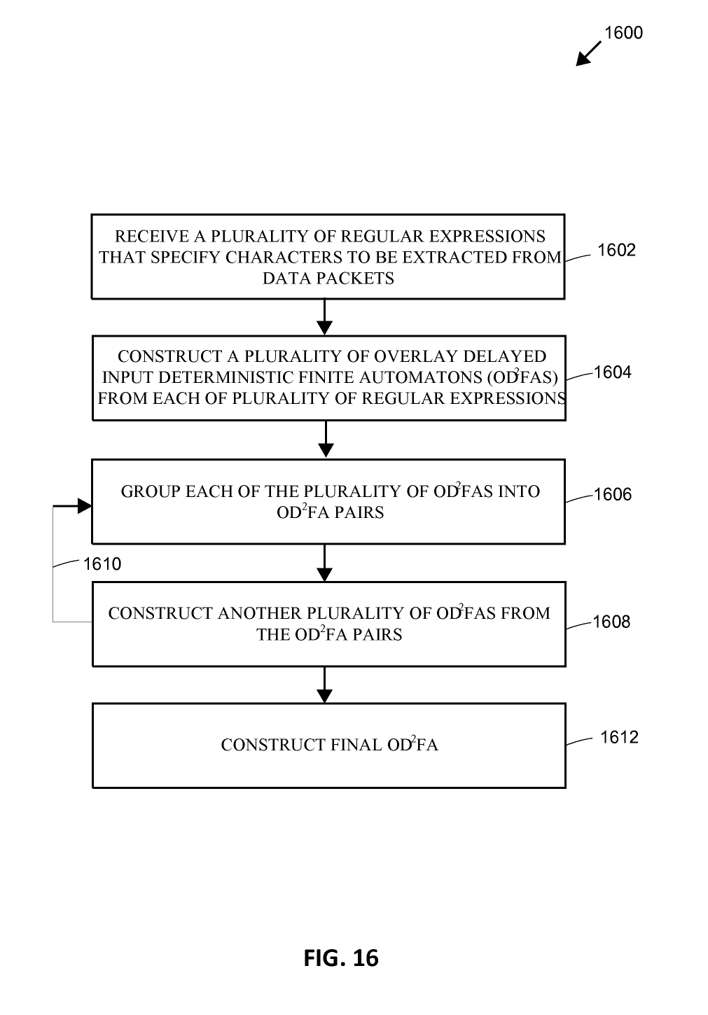

FIG. 16 is a flow diagram of an example method 1600 in accordance with an embodiment of the present disclosure. In the present embodiment, method 1600 may be implemented by any suitable computing device (e.g., packet inspection module 1502, as shown in FIG. 15). In one aspect, method 1600 may be performed by one or more processors, applications, routines, and/or algorithms, such as any suitable portion of CPU 1508 executing one or more algorithms via execution of one or more of the modules stored in memory 1520, for example, as shown in FIG. 15.

Method 1600 begins at block 1602, in which one or more processors receive a plurality of regular expressions that specify characters to be extracted from data packets. The one or more processors could be, for example, a CPU, such as CPU 1508, as shown in FIG. 15, in an embodiment. The regular expressions could be received from, for example, a portion of a memory, such as regular expression module 1526, as shown in FIG. 15, for example, in an embodiment.

At block 1604, method 1600 includes constructing a plurality of overlay delayed input deterministic finite automatons (OD²DFAs) from each of the plurality of regular expressions. The plurality of two OD²DFAs could include, for example, the two OD²DFAs as shown in FIGS. 5 and 6, which correspond to two respective OD²DFA constructions from a single regular expression, in an embodiment.

At block 1606, method 1600 includes grouping each of the plurality of OD²DFAs into OD²FA pairs. These OD²DFA pairs could include, for example, a merged OD²DFA construction from two OD²DFAs, such as the merged OD²DFA as shown in FIG. 7B, for example, which was merged from the two OD²DFAs shown in FIGS. 5 and 6, in an embodiment.

At block 1608, method 1600 includes constructing another plurality of OD²FAs from the OD²FA pairs. This could include, for example, a continued construction of the merged OD²DFAs as previously discussed with reference to block 1604, but applied to the OD²DFA pairs grouped together in block 1608, in an embodiment.

At block 1610, the acts discussed with reference to blocks 1606 and 1608 are repeated until a final OD²DFA construction is reached at block 1612. Bocks 1610 and 1612 could include, for example, an execution of a suitable version of an OD2FAMerge Algorithm, as shown in Appendix A for example, to obtain an optimized OD²DFA as illustrated in FIG. 7C, in an embodiment.

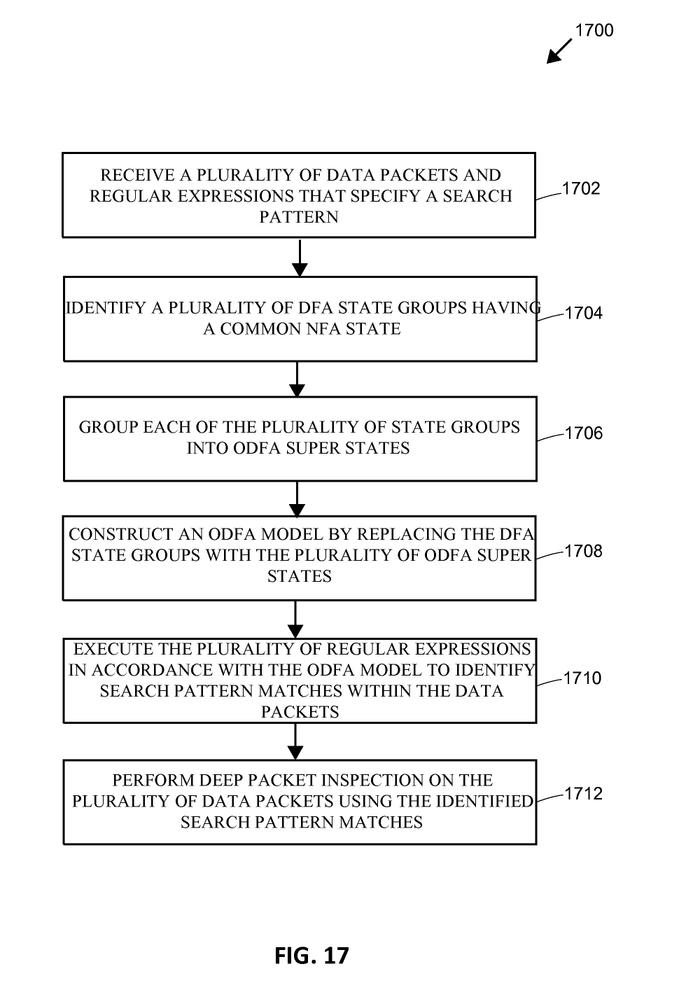

FIG. 17 is a flow diagram of an example method 1700 in accordance with an embodiment of the present disclosure. In the present embodiment, method 1700 may be implemented by any suitable computing device (e.g., packet inspection module 1502, as shown in FIG. 15). In one aspect, method 1700 may be performed by one or more processors, applications, routines, and/or algorithms, such as any suitable portion of CPU 1508 executing one or more algorithms via execution of one or more of the modules stored in memory 1520, for example, as shown in FIG. 15.

Method 1700 may start when one or more processors receive a plurality of data packets and a plurality of regular expressions that specify a search pattern (block 1702). The plurality of data packets may be received, for example, via any suitable network (e.g., network 1504, as shown in FIG. 15) (block 1702). The plurality of regular expressions may be provided, for example, as part of an input into a suitable computing device and/or a parameter that is specified when one or more algorithms are executed for deep packet inspection (block 1702).

Method 1700 may include one or more processors identifying a plurality of deterministic finite automata (DFA) state groups (block 1704). In an embodiment, this may include, for example, grouping each of the plurality of DFA state groups having a common nondeterministic finite automata (NFA) state (block 1704). As previously discussed, the plurality of DFA state groups may include DFA source states and DFA destination states (block 1704).

Method 1700 may include one or more processors grouping each of the plurality of DFA state groups into overlay DFA (ODFA) super states (block 1706). In an embodiment, the ODFA super states may be constructed such that replicated transitions between DFA source states grouped within the same source ODFA super state and the same DFA destination state are aggregated as a single transition between the source ODFA super state and the DFA destination state (block 1706), such as the ODFA with super state transitions as shown and previously discussed with respect to FIG. 2D, for example.

Method 1700 may include one or more processors constructing an ODFA model by replacing the plurality of DFA state groups with the plurality of OFDA super states based upon the received plurality of regular expressions (block 1708). This may include, for example, the execution of one or more suitable algorithms from a given set of regular expressions, which are not shown for purposes of brevity but may be included by one or more construction algorithms for OD²FA as discussed herein.

Method 1700 may include one or more processors executing the plurality of regular expressions in accordance with the model of the ODFA model to identify search pattern matches within the plurality of data packets. (block 1710). This may include, for example, one or more processors executing an algorithm to search an input string in accordance with the search pattern specified by one or more regular expressions in accordance with the constructed ODFA model, as shown in FIG. 2D, for example, in which an input string “abea” is searched.

Method 1700 may include one or more processors performing deep packet inspection on the plurality of data packets based upon identified search pattern matches (block 1712). This may include, for example, processing and/or examining a data portion and/or header of one or more received data packets to determine the presence of protocol non-compliance, viruses, spam, intrusions, a defined criteria to decide whether the packet may pass or if it needs to be routed to a different destination, the collection of statistical information, etc. (block 1712).

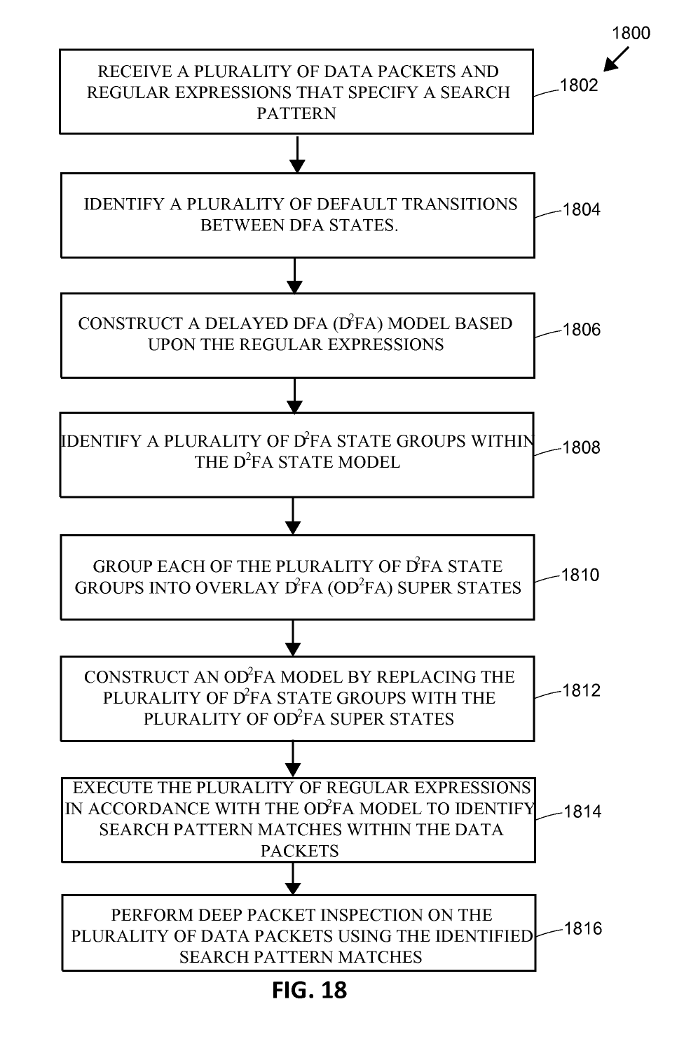

FIG. 18 is a flow diagram of an example method 1800 in accordance with an embodiment of the present disclosure. In the present embodiment, method 1800 may be implemented by any suitable computing device (e.g., packet inspection module 1502, as shown in FIG. 15). In one aspect, method 1800 may be performed by one or more processors, applications, routines, and/or algorithms, such as any suitable portion of CPU 1508 executing one or more algorithms via execution of one or more of the modules stored in memory 1520, for example, as shown in FIG. 15.

Method 1800 may start when one or more processors receive (i) a plurality of data packets, and (ii) a plurality of regular expressions that specify a search pattern (block 1802). The plurality of data packets may be received, for example, via any suitable network (e.g., network 1504, as shown in FIG. 15) (block 1802). The plurality of regular expressions may be provided, for example, as part of an input into a suitable computing device and/or a parameter that is specified when one or more algorithms are executed for deep packet inspection (block 1802).

Method 1800 may include one or more processors identifying a plurality of default transitions between deterministic finite automata (DFA) states (block 1804). In an embodiment, these DFA states may be part of a DFA transition function based upon the plurality of received regular expressions (block 1804). Further in accordance with such an embodiment, each of the default transitions may represent a plurality of common transitions between DFA states and constitute a deferment transition (block 1804).

Method 1800 may include one or more processors constructing a delayed DFA (D²FA) model based upon the regular expressions (block 1806). In an embodiment, the D²FA model may be constructed by replacing the plurality of common transitions with their corresponding default transitions (block 1806). In an embodiment, the plurality of default transitions may include, for example, those shown and described with respect to FIG. 3A (block 1806).

Method 1800 may include one or more processors identifying a plurality of D²FA state groups within the D²FA state model (block 1808). In an embodiment, this may include, for example, identifying each of the plurality of D²FA state groups having a common DFA state (block 1808). As previously discussed, the plurality of D²FA state groups may include D²FA source states and D²FA destination states (block 1808).

Method 1800 may include one or more processors grouping each of the plurality of D²FA state groups into overlay D²FA (OD²FA) super states (block 1810). In an embodiment, the OD²FA super states may include D²FA state groups such that (i) replicated transitions between D²FA source states grouped within the same source OD²FA super state and D²FA destination states grouped within the same destination OD²FA super state are aggregated as a single transition between the source OD²FA super state and the destination OD²FA super state, and (ii) deferment transition relationships between D²FA states are represented as transitions between one or more OD²FA super states (block 1810).

Method 1800 may include one or more processors constructing an OD²FA model by replacing the plurality of D²FA state groups with the plurality of OD²FA super states (block 1812). In an embodiment, the plurality of OD²FA super states may be grouped based upon the received plurality of regular expressions (block 1812). This OD²FA model may include, for example, the OD²FA model shown and described with respect to FIG. 3B (block 1812). In an embodiment, this may include the construction of the OD²FA model via one or more suitable OD²FA construction algorithms, such as OD²FAMerge, DirectOD2FAMerge, the overlay classifiers algorithm, the overlay classifier minimizing algorithm, etc., as previously discussed herein (block 1812).

Method 1800 may include one or more processors executing the plurality of regular expressions in accordance with the OD²FA model to identify search pattern matches within the plurality of data packets (block 1814). This may include, for example, one or more processors executing an algorithm to search an input string in accordance with the search pattern specified by one or more regular expressions in accordance with the constructed OD²FA model, as shown in FIG. 3B, for example.

Method 1800 may include one or more processors performing deep packet inspection on the plurality of data packets based upon identified search pattern matches (block 1816). This may include, for example, processing and/or examining a data portion and/or header of one or more received data packets to determine the presence of protocol non-compliance, viruses, spam, intrusions, a defined criteria to decide whether the packet may pass or if it needs to be routed to a different destination, the collection of statistical information, etc. (block 1816).

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any suitable computer readable storage medium such as on a magnetic disk, an optical disk, in a RAM or ROM or flash memory, tape drive, etc. Likewise, the software or firmware instructions may be delivered to a user or a system via any known or desired delivery method. The software or firmware instructions may include machine readable instructions that, when executed by the processor, cause the processor to perform various acts.

While various aspects of the present invention have been described with reference to specific examples, which are intended to be illustrative only and not to be limiting of the invention, changes, additions and/or deletions may be made to the disclosed embodiments without departing from the scope of the invention.

What is claimed is:

1. (ODFA algorithm) A computer-implemented method for implementing regular expression matching, comprising:
receiving, by one or more processors, (i) a plurality of data packets, and (ii) a plurality of regular expressions that specify a search pattern;
identifying, by one or more processors, a plurality of deterministic finite automata (DFA) state groups, each of the plurality of DFA state groups having a common nondeterministic finite automata (NFA) state and including DFA source states and DFA destination states;
grouping, by one or more processors, each of the plurality of DFA state groups into overlay DFA (ODFA) super states such that replicated transitions between DFA source states grouped within the same source ODFA super state and the same DFA destination state are aggregated as a single transition between the source ODFA super state and the DFA destination state;
constructing, by one or more processors, an ODFA model by replacing the plurality of DFA state groups with the plurality of OFDA super states based upon the received plurality of regular expressions;
executing, by one or more processors, the plurality of regular expressions in accordance with the model of the ODFA model to identify search pattern matches within the plurality of data packets; and
performing, by one or more processors, deep packet inspection on the plurality of data packets based upon identified search pattern matches.

2. (Claim 1 above gives a generic example of super state to DFA states, this clarifies that the destination state is also a super state) The computer-implemented method of claim 1, wherein the same DFA destination state is from among a plurality of common destination DFA state groups corresponding to each of the DFA source states constituting the source ODFA super state, and further comprising:
grouping the plurality of common destination DFA state groups into a destination ODFA super state such that replicated transitions between (i) DFA source states constituting the source ODFA super state and (ii) the DFA destination states constituting the destination ODFA super state are aggregated as a single transition between the source ODFA super state and the destination ODFA super state.

3. (Portion of OFDA algorithm that maximizes the number of transitions that are grouped into super state transitions) The computer-implemented method of claim 1, wherein the act of grouping comprises:
grouping a maximum number of DFA state groups into a plurality of OFDA super states based upon the received plurality of regular expressions.

4. (Best case scenario—every state replaced with a super state and a reduction of 50% state transitions) The computer-implemented method of claim 1, wherein a first total number of state transitions corresponding to the plurality of DFA state groups is greater than a second total number of ODFA super state transitions by a factor of 2.

5. (Implementation of super states as a TCAM entry) The computer-implemented method of claim 1, further comprising:
building a ternary content addressable memory (TCAM) table from the ODFA model such that the single transition between the source ODFA super state and the DFA destination state represents a single TCAM table entry.

6. A non-transitory, tangible computer-readable medium storing machine readable instructions that, when executed by a processor, cause the processor to:
receive (i) a plurality of data packets, and (ii) a plurality of regular expressions that specify a search pattern;
identify a plurality of deterministic finite automata (DFA) state groups, each of the plurality of DFA state groups having a common nondeterministic finite automata (NFA) state and including DFA source states and DFA destination states;
group each of the plurality of DFA state groups into overlay DFA (ODFA) super states such that replicated transitions between DFA source states grouped within the same source ODFA super state and the same DFA destination state are aggregated as a single transition between the source ODFA super state and the DFA destination state;
construct an ODFA model by replacing the plurality of DFA state groups with the plurality of OFDA super states based upon the received plurality of regular expressions;
execute the plurality of regular expressions in accordance with the model of the ODFA model to identify search pattern matches within the plurality of data packets; and
perform deep packet inspection on the plurality of data packets based upon identified search pattern matches.

7. The non-transitory, tangible computer-readable medium of claim 6, wherein the same DFA destination state is from among a plurality of common destination DFA state groups corresponding to each of the DFA source states constituting the source ODFA super state, and further including instructions that, when executed by the processor, cause the processor to:
group the plurality of common destination DFA state groups into a destination ODFA super state such that replicated transitions between (i) DFA source states constituting the source ODFA super state and (ii) the DFA destination states constituting the destination ODFA super state are aggregated as a single transition between the source ODFA super state and the destination ODFA super state.

8. The non-transitory, tangible computer-readable medium of claim 6, wherein the instructions to group each of the plurality of DFA state groups into overlay DFA (ODFA) super states further includes instructions that, when executed by the processor, cause the processor to:
group a maximum number of DFA state groups into a plurality of OFDA super states based upon the received plurality of regular expressions.

9. The non-transitory, tangible computer-readable medium of claim 6, wherein a first total number of state transitions corresponding to the plurality of DFA state groups is greater than a second total number of ODFA super state transitions by a factor of 2.

10. The non-transitory, tangible computer-readable medium of claim 6, further including instructions that, when executed by the processor, cause the processor to:
build a ternary content addressable memory (TCAM) table from the ODFA model such that the single transition between the source ODFA super state and the DFA destination state represents a single TCAM table entry.

11. (OD2FA model) A computer-implemented method for implementing regular expression matching, comprising:
receiving, by one or more processors, (i) a plurality of data packets, and (ii) a plurality of regular expressions that specify a search pattern;
identifying, by one or more processors, a plurality of default transitions between deterministic finite automata (DFA) states in a DFA transition function based upon the plurality of received regular expressions, each of the default transitions representing a plurality of common transitions between DFA states and constituting a deferment transition, constructing, by one or more processors, a delayed DFA (D²FA) model by replacing the plurality of common transitions with their corresponding default transitions;
identifying, by one or more processors, a plurality of D²FA state groups within the D²FA state model, each of the plurality of D²FA state groups having a common DFA state and including D²FA source states and D²FA destination states;
grouping, by one or more processors, each of the plurality of D²FA state groups into overlay D²FA (OD²FA) super states such that (i) replicated transitions between D²FA source states grouped within the same source OD²FA super state and D²FA destination states grouped within the same destination OD²FA super state are aggregated as a single transition between the source OD²FA super state and the destination OD²FA super state, and (ii) deferment transition relationships between D²FA states are represented as transitions between one or more OD²FA super states;
constructing, by one or more processors, an OD²FA model by replacing the plurality of D²FA state groups with the plurality of OD²FA super states based upon the received plurality of regular expressions;
executing, by one or more processors, the plurality of regular expressions in accordance with the OD²FA model to identify search pattern matches within the plurality of data packets; and
performing, by one or more processors, deep packet inspection on the plurality of data packets based upon identified search pattern matches.

12. (OD2FA Construction Algorithm—previously an independent claim) The computer-implemented method of claim 11, wherein the act of constructing the OD²FA model comprises:
constructing a plurality of OD²FAs from each of the plurality of regular expressions;
grouping each of the plurality of OD²FAs into OD²FA pairs;
constructing a second plurality of OD²FAs from the OD²FA pairs; and
repeating the acts of grouping and constructing the plurality of OD²FAs from grouped OD²FA pairs to construct the OD²FA model for the plurality of regular expressions.

13. The method according to claim 11, further comprising:
building a ternary content addressable memory (TCAM) table from the OD²FA model; and
processing characters to be extracted from the plurality of data packets by utilizing the TCAM table to process one of the characters in a period of time.

14. The method according to claim 1, further comprising:
building a ternary content addressable memory (TCAM) table from the OD²FA model; and
processing the characters to be extracted from the data packets by utilizing the TCAM table to process more than one of the characters in a period of time.

15. The method according to claim 11, further comprising:
storing, by one or more processors, the deferment transition relationships on a super state level as deferment transitions between one or more OD²FA super states.

16. A non-transitory, tangible computer-readable medium storing machine readable instructions that, when executed by a processor, cause the processor to:
receive (i) a plurality of data packets, and (ii) a plurality of regular expressions that specify a search pattern;
identify a plurality of default transitions between deterministic finite automata (DFA) states in a DFA transition function based upon the plurality of received regular expressions, each of the default transitions representing a plurality of common transitions between DFA states and constituting a deferment transition,
construct a delayed DFA (D²FA) model by replacing the plurality of common transitions with their corresponding default transitions;
identify a plurality of D²FA state groups within the D²FA state model, each of the plurality of D²FA state groups having a common DFA state and including D²FA source states and D²FA destination states;
group each of the plurality of D²FA state groups into overlay D²FA (OD²FA) super states such that (i) replicated transitions between D²FA source states grouped within the same source OD²FA super state and D²FA destination states grouped within the same destination OD²FA super state are aggregated as a single transition between the source OD²FA super state and the destination OD²FA super state, and (ii) deferment transition relationships between D²FA states are represented as transitions between one or more OD²FA super states;
construct an OD²FA model by replacing the plurality of D²FA state groups with the plurality of OD²FA super states based upon the received plurality of regular expressions;
execute the plurality of regular expressions in accordance with the OD²FA model to identify search pattern matches within the plurality of data packets; and
perform deep packet inspection on the plurality of data packets based upon identified search pattern matches.

17. The non-transitory, tangible computer-readable medium of claim 16, wherein the instructions to construct the OD²FA model further including instructions that, when executed by the processor, cause the processor to:
construct a plurality of OD²FAs from each of the plurality of regular expressions;
group each of the plurality of OD²FAs into OD²FA pairs;
construct a second plurality of OD²FAs from the OD²FA pairs; and
repeat the acts of grouping and constructing the plurality of OD²FAs from grouped OD²FA pairs to construct the OD²FA model for the plurality of regular expressions.

18. The non-transitory, tangible computer-readable medium of claim 16, further including instructions that, when executed by the processor, cause the processor to:
build a ternary content addressable memory (TCAM) table from the OD²FA model; and
process characters to be extracted from the plurality of data packets by utilizing the TCAM table to process one of the characters in a period of time.

19. The non-transitory, tangible computer-readable medium of claim 16, further including instructions that, when executed by the processor, cause the processor to:
build a ternary content addressable memory (TCAM) table from the OD²FA model; and
process the characters to be extracted from the data packets by utilizing the TCAM table to process more than one of the characters in a period of time.

20. The non-transitory, tangible computer-readable medium of claim 16, further including instructions that, when executed by the processor, cause the processor to:
store the deferment transition relationships on a super state level as deferment transitions between one or more OD²FA super states.
